(19) United States
(12) Patent Application Publication
(10) Pub. No.: US 2008/0213507 A1
(43) Pub. Date: Sep. 4, 2008

(54) POLYMER FILM, PROCESS FOR PRODUCING THE SAME, AND POLARIZING PLATE AND LIQUID CRYSTAL DISPLAY USING THE SAME

(75) Inventors: Nobutaka Fukagawa, Minami-Ashigara-shi (JP); Mitsuo Yoshikane, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/872,958

(22) Filed: Oct. 16, 2007

(30) Foreign Application Priority Data
Oct. 16, 2006 (JP) 2006-281559

(51) Int. Cl. B32B 27/00; C09K 19/52; B29C 55/02

(52) U.S. Cl. 428/1.1; 428/220; 264/291

(57) ABSTRACT

A polymer film has a coefficient of fluctuation in degree of out-of-plane orientation of a polymer molecular chain in a thickness direction of the film as represented by the following numerical expression (1) as defined herein of from 15% to 80%.

### FIELD OF THE INVENTION

The present invention relates a polymer film and a process for producing the same and to a polarizing plate and a liquid crystal display each using the same.

### BACKGROUND OF THE INVENTION

The market of liquid crystal television sets is rapidly spreading centering on the large size. Following this, a demand for enhancing the image quality of a liquid crystal display is remarkably rising. In particular, display unevenness is easily viewed with an increase in the size, and therefore, a requirement for the improvement is strong with respect of the generation of unevenness following the change in temperature and relative humidity.

It was thought that the generation of unevenness following the change in temperature and relative humidity is caused due to the occurrence of light leakage by stress birefringence because dimensional changes in a stretched polyvinyl alcohol film and a polarizing plate protective film and/or an adhesive to be used in a polarizer are different.

With respect to this issue, JP-A-2003-279743 discloses a method of making an elastic modulus of a polarizing plate protective film large; and JP-A-2004-163606 discloses a method of making a thickness of a polarizing plate protective film large. However, since these methods involve such a defect that the curl control of the polarizing plate or handling properties of the polarizing plate in a rolled state are difficult, and therefore, improvements have been demanded.

### SUMMARY OF THE INVENTION

An object of the invention is to provide a polymer film for polarizing plate protective film which, when built in a liquid crystal display, hardly causes display unevenness and which has an excellent aptitude for processing into a polarizing plate and a process for producing the same.

Also, another object of the invention is to provide a liquid crystal display using the subject polymer film, which hardly generates unevenness and which has a high display grade.

The present inventors made extensive and intensive investigations. As a result, it has been found that the generation of unevenness caused due to the change in temperature and relative humidity can be reduced by controlling the out-of-plane orientation of a cellulose acylate molecular chain in a polymer film, concretely a cellulose acylate film, leading to completion of the invention.

That is, the foregoing objects of the invention have been achieved by the following constitutions [1] to [14].

[1] A polymer film having a coefficient of fluctuation in degree of out-of-plane orientation of a polymer molecular chain in a thickness direction of the film as represented by the following numerical expression (1) of 15% or more and not more than 80%.

(Coefficient of fluctuation in degree of out-of-plane orientation)=100×[(Maximum value of degree of out-of-plane orientation)−(Minimum value of degree of out-of-plane orientation)]/(Average value of degree of out-of-plane orientation in thickness direction) Numerical Expression (1)

[2] The polymer film as set forth in [1], having a coefficient of fluctuation in in-plane retardation Re at a wavelength of 590 nm as represented by the following numerical expression (2) of not more than 20%.

(Coefficient of fluctuation in Re)=100×[(Maximum value of Re)−(Minimum value of Re)]/(Average value of Re) Numerical Expression (2)

[3] The polymer film as set forth in [1] or [2], wherein when a larger value between an average value of degrees of out-of-plane orientation of a polymer molecular chain in a region of from a surface of one side of the film to a depth of 10 μm and an average value of degrees of out-of-plane orientation of a polymer molecular chain in a region of from a surface of opposite side of the film to a depth of 10 μm is defined as Ps and a degree of out-of-plane orientation of a polymer molecular chain in the center in a thickness direction of the film is defined as Pc, Ps and Pc are satisfied with the relationship of the following numerical expression (3).

1.15≦Ps/Pc≦2.00 Numerical Expression (3)

[4] The polymer film as set forth in [1] or [2], wherein Ps and Pc are satisfied with the relationship of the following numerical expression (4).

0.50≦Ps/Pc≦0.95 Numerical Expression (4)

[5] The polymer film as set forth in any one of [1] to [4], wherein an in-plane retardation Re at a wavelength of 590 nm and a retardation Rth in a thickness direction are satisfied with the relationships of the following numerical expressions (5) to (7).

20≦Re≦200 Numerical Expression (5)

70≦Rth≦400 Numerical Expression (6)

1≦Rth/Re≦10 Numerical Expression (7)

[6] The polymer film as set forth in any one of [1] to [5], wherein the film has a thickness of 20 μm or more and not more than 100 μm.
[7] A process for producing a polymer film including casting a dope containing a polymer and a solvent and having a gel point of no higher than −15° C. on a support, drying, stripping off from the support and stretching the stripped-off film, wherein the content of the residual solvent at the start of stretching as represented by the following numerical expression (8) is 20% or more and not more than 140%, and a stretching rate is 5%/min or more and not more than 100%/min.

[Content of residual solvent(% by mass)]=100×{[Film mass(g)]−[Film mass(g)after drying at 120° C. for 2 hours]}/[Film mass(g)after drying at 120° C. for 2 hours] Numerical Expression (8)

[8] The process for producing a polymer film as set forth in [7] including casting a dope containing a polymer and a poor solvent and a good solvent relative to the polymer and having a gel point of no higher than −15° C. on a support, drying, stripping off from the support and stretching the stripped-off film, wherein at a point of time when the content of the residual solvent represented by the numerical expression (8) is 160%, a ratio of the poor solvent to the total solvents is 1.2 times or more of a ratio of the poor solvent to the total solvents in the dope.
[9] A process for producing a polymer film including casting a dope containing a polymer and a solvent and having a gel point of −10° C. or higher on a support, drying, stripping off from the support and stretching the stripped-off film, wherein the content of the residual solvent at the start of stretching as represented by the following numerical expression (8) is 20% or more and not more than 140%, and a stretching rate is 5%/min or more and not more than 100%/min.

[Content of residual solvent(% by mass)]=100×{[Film mass(g)]−[Film mass(g)after drying at 120° C. for 2 hours]}/[Film mass(g)after drying at 120° C. for 2 hours] Numerical Expression (8)

[10] The polymer film as set forth in any one of [1] to [3], [5] and [6], which is produced by the process as set forth in [7] or [8].
[11] The polymer film as set forth in any one of [1], [2] and [4] to [6], which is produced by the process as set forth in [9].
[12] The polymer film as set forth in any one of [1] to [6], [10] and [11], wherein the polymer film contains cellulose acylate.
[13] A polarizing plate comprising a protective film stuck on both sides of a polarizer, wherein at least one of the protective films is the polymer film as set forth in any one of [1] to [6] and [10] to [12].
[14] A liquid crystal display comprising a liquid crystal cell and two polarizing plates disposed on both sides thereof, wherein at least one of the polarizing plates is the polarizing plate as set forth in [13].

According to the invention, there are provided a polymer film which has an excellent aptitude for processing into a polarizing plate, which, when built in a liquid crystal display, hardly generates display unevenness and which is useful as a protective film or an optical compensation film; and a process for producing the same.

Also, according to the invention, there are provided a polarizing plate using the subject polymer film, which is able to display a high-grade image; and a liquid crystal display using the same.

### BRIEF DESCRIPTION OF THE DRAWINGS

FIGS. 1A and 1B are each a cross-sectional view for explaining one example of a composite configuration of a polarizing plate of the invention and a functional optical film.

FIG. 2 is a view for explaining one example of a liquid crystal display in which a polarizing plate of the invention is used.

FIG. 3 is a cross-sectional view for explaining one example of a VA mode liquid crystal display in which a polarizing plate of the invention is used.

### DESCRIPTION OF REFERENCE NUMERALS AND SIGNS

1, 1a, 1b: Protective film
2: Polarizer
3: Functional optical film
4: Adhesive layer
5: Polarizing plate
6: Upper polarizing plate
7: Upper polarizing plate absorption axis
8: Upper optically anisotropic layer
9: Upper optically anisotropic layer orientation controlling direction
10: Liquid crystal cell upper electrode substrate
11: Upper substrate orientation controlling direction
12: Liquid crystal molecule
13: Liquid crystal cell lower electrode substrate
14: Lower substrate orientation controlling direction
15: Lower optically anisotropic layer
16: Lower optically anisotropic layer orientation controlling direction
17: Lower polarizing plate
18: Lower polarizing plate absorption axis
30: Upper polarizing plate
31: VA mode liquid crystal cell
32: Lower polarizing plate
33: Cellulose acylate film
34: Polarizer

### DETAILED DESCRIPTION OF THE INVENTION

The invention is hereunder described in detail. In the following, a film containing cellulose acylate as a main component (cellulose acylate film) which is especially favorable as the polymer film of the invention is described as an example.

### <Cellulose Acylate Film>

The cellulose acylate film which is used in the invention is characterized in that a coefficient of fluctuation in degree of orientation in a thickness direction of a cellulose acylate molar chain in the film thickness direction (the degree of orientation will be hereinafter referred to as “degree of out-of-plane orientation”) falls within a specified range.

In the invention, the degree of out-of-plane orientation can be determined by dividing equally into 5 to 10 parts from the support side to the air interface side at the fabrication with respect to cross sections parallel to the xz plane and yz plane of the film, measuring a degree of orientation of the polymer molecular chain in the film cross section of each of these parts by using X-ray beams of from several μm to several tens μm and calculating on the basis of the following numerical expression (9).

(Degree of out-of-plane orientation)=[(Degree of orientation of cellulose acylate molecular chain on the xz plane)+(Degree of orientation of cellulose acylate molecular chain on the yz plane)]/2 Numerical Expression (9)

In the numerical expression (9), the stretching direction of the film is designated as “x direction”; the thickness direction of the film is designated as “z direction”; and the direction vertical to both the x direction and the z direction is designated as “y direction”.

A degree of orientation P of the polymer molecular chain can be calculated from an average value of peak intensities of 2θ=6 to 11° in the transmission two-dimensional X-ray measurement according to the following numerical expression (10).

P=(3 cos²β−1)/2 Numerical Expression (10)

Here, cos²β is represented by the following numerical expression (11).

cos²β=∫₀^{π}cos²β·I(β)·sin βdβ/∫₀^{π}I(β)·sin βdβ Numerical Expression (11)

The cellulose acylate film of the invention has a coefficient of fluctuation in degree of out-of-plane orientation as represented by the following numerical expression (1) of 15% or more and not more than 80%:

(Coefficient of fluctuation in degree of out-of-plane orientation)=100×[(Maximum value of degree of out-of-plane orientation)−(Minimum value of degree of out-of-plane orientation)]/(Average value of degree of out-of-plane orientation in thickness direction) Numerical Expression (1)

The “average value of degree of out-of-plane orientation in thickness direction” as referred to herein means an average value of the degree of out-of-plane orientation in a thickness direction of the film and refers to an average value of values of the degree of out-of-plane orientation in the thickness direction as measured in 5 to 10 parts from a surface of one side to a surface of an opposite side thereto. Also, the “maximum value of degree of out-of-plane orientation” and “minimum value of degree of out-of-plane orientation” refer to a maximum value and a minimum value of values of the degree of out-of-plane orientation in the thickness direction as measured in 5 to 10 parts from a surface of one side to a surface of an opposite side thereto, respectively.

The coefficient of fluctuation in degree of out-of-plane orientation is preferably 20% or more and not more than 60%, and more preferably 25% or more and not more than 45%.

In polarizing plate protective films to be used in related-art liquid crystal displays, it was thought that ones having uniform physical properties and material quality as far as possible are favorable from the standpoint of reducing the unevenness. However, it has been unexpectedly found by the present inventors that with respect to the display unevenness following the change in temperature and relative humidity, a film having a large fluctuation in degree of out-of-plane orientation in the film thickness direction hardly generates the unevenness.

It is thought that this is caused due to the matter that in the case of the related-art display unevenness, the unevenness of a polarizing plate protective film itself is a cause, whereas in the case of the display unevenness following the change in temperature and relative humidity, a polarizing plate protective film controls the shrinkage of a polarizer following the temperature and relative humidity, and a stress is generated in the polarizing plate protective film. That is, in the case of the display unevenness following the change in temperature and relative humidity, the foregoing stress, in its turn the retardation generated on the polarizing plate protective film following the stress becomes non-uniform in a liquid crystal display plane, and a light leakage pattern reflecting stress distribution in black displaying is observed.

Accordingly, in order to reduce the foregoing display unevenness following the change in temperature and relative humidity, it is thought to be important not to transmit an influence of a shrinkage force generated in a polarizer over the whole of the polarizing plate protective film (to limit it to the vicinity of the interface portion with the polarizer).

It is estimated that in the foregoing film having a large fluctuation in degree of out-of-plane in the film thickness direction, an influence of a shrinkage force of a polarizer is limited to only the vicinity of the interface with the polarizer, whereby the display unevenness is reduced.

On the other hand, the degree of out-of-plane orientation is a factor to influence an elastic modulus of the film. When the fluctuation in degree of out-of-plane orientation in the thickness direction is too large, the stiffness of the film becomes non-uniform in the thickness direction, and curl is easily generated.

Accordingly, in the invention, when the coefficient of fluctuation in degree of out-of-plane orientation is less than 15%, an effect for reducing the display unevenness following the change in temperature and relative humidity is small. On the other hand, when the coefficient of fluctuation in degree of out-of-plane orientation exceeds 80%, curl in the film single body is large, and a problem that the productivity in the film production step and the polarizing plate processing step is reduced is caused.

In the cellulose acylate film of the invention, by adjusting the degree of out-of-plane orientation in the film thickness direction in desired distribution, when built in a liquid crystal display, the display unevenness following the change in temperature and relative humidity can be reduced.

The distribution in degree of out-of-plane orientation in the film thickness direction of the cellulose acylate film of the invention is hereunder described.

A first preferred embodiment of the distribution in degree of out-of-plane orientation in the film thickness direction of the cellulose acylate film of the invention is one in which when a larger value between an average value of degrees of out-of-plane orientation of a polymer molecular chain in a region of from a surface of one side of the film to a depth of 10 μm and an average value of degrees of out-of-plane orientation of a polymer molecular chain in a region of from a surface of opposite side of the film to a depth of 10 μm is defined as Ps and a degree of out-of-plane orientation of a polymer molecular chain in the center in a thickness direction of the film is defined as Pc, Ps and Pc are satisfied with the relationship of the following numerical expression (3) (this distribution will be hereinafter referred to as “distribution A”).

The “film surface” as referred to in the invention refers to a plane coming into contact with the support at the fabrication and a plane on the air side.

Also, the “degree of out-of-plane orientation” as referred to herein refers to an average value of values of the degree of out-of-plane orientation as measured in from 5 to 10 parts in a region of from the film surface to a depth of 10 μm and in the center in a thickness direction of the film.

1.15≦Ps/Pc≦2.00 Numerical Expression (3)

The numerical expression (3) is more preferably the following numerical expression (3-2), and most preferably the following numerical expression (3-3).

1.20≦Ps/Pc≦1.80 Numerical Expression (3-2)

1.25≦Ps/Pc≦1.60 Numerical Expression (3-3)

Also, a second preferred embodiment of the distribution in degree of out-of-plane orientation in the film thickness direction of the cellulose acylate film of the invention is one in which the foregoing Ps and Pc are satisfied with the relationship of the following numerical expression (4) (this distribution will be hereinafter referred to as “distribution B”).

0.50≦Ps/Pc≦0.95 Numerical Expression (4)

The numerical expression (4) is more preferably the following numerical expression (4-2), and most preferably the following numerical expression (4-3).

0.60≦Ps/Pc≦0.90 Numerical Expression (4-2)

0.70≦Ps/Pc≦0.80 Numerical Expression (4-3)

By properly selecting the distribution A and the distribution B depending upon conditions such as a stretching ratio of a polarizer to be used in a polarizing plate, an angle formed by an absorption axis of the polarizer and a panel long-side direction, film physical properties and film thickness of a protective film on an opposite side relative to the polarizer, and the kind of an adhesive, when built in a liquid crystal display, the display unevenness following the change in temperature and relative humidity can be reduced without impairing a processing aptitude for processing into a polarizing plate such as curl.

The distribution in degree of out-of-plane orientation in the film thickness direction of the cellulose acylate film of the invention can be adjusted by a correlation between volatilization rate and diffusion rate of a solvent at the fabrication, distribution of an additive with low affinity with the polymer in the film thickness direction, the content of the residual solvent in the film at the stretching operation and the progress of gelation. The cellulose acylate film of the invention is hereunder described in detail.

### [Cellulose Acylate]

First of all, cellulose acylate which is used in the invention is described.

A basic principle of the synthesis of cellulose acylate is described in Migita, et al., Wood Chemistry, pages 180 to 190 (Kyoritsu Shuppan, 1968). A representative synthesis method is a liquid phase acetylation method by a carboxylic acid anhydride-acetic acid-sulfuric acid catalyst. Concretely, a cellulose raw material such as cotton linter and wood pulps is subjected to a pretreatment with an appropriate amount of acetic acid and then thrown into a previously cooled carboxylic acid mixed liquid to achieve esterification, thereby synthesizing complete cellulose acylate (the total acyl substitution degree at the 2-position, 3-position and 6-position is substantially 3.00). In general, the foregoing carboxylic acid mixed liquid contains acetic acid as a solvent, an anhydrous carboxylic acid as an esterifying agent and sulfuric acid as a catalyst. It is general that the anhydrous carboxylic acid is used in a stoichiometrically excessive amount to the total sum of the cellulose with which the anhydrous carboxylic acid reacts and the moisture existing in the system. After completion of the acylation reaction, in order to achieve hydrolysis of the excessive anhydrous carboxylic acid remaining in the system and neutralization of a part of the esterification catalyst, an aqueous solution of a neutralizing agent (for example, carbonates, acetates or oxides of calcium, magnesium, iron, aluminum or zinc) is added. Next, the resulting cellulose acylate is kept at from 50 to 90° C. in the presence of a small amount of an acetylation reaction catalyst (in general, residual sulfuric acid) to achieve saponification ripening, whereby it is converted into cellulose acylate having desired acyl substitution degree and polymerization degree. At a point of time of obtaining the desired cellulose acylate, the cellulose acylate solution is thrown into water or dilute sulfuric acid (or water or dilute sulfuric acid is thrown into the cellulose acylate solution) by completely neutralizing the catalyst remaining in the system with the foregoing neutralizing agent or without neutralizing it, thereby separating the cellulose acylate, followed by washing and stabilization to obtain cellulose acylate.

In the cellulose acylate film of the invention, it is preferable that a polymer component constituting the film is substantially composed of the foregoing preferred cellulose acylate. The term “substantially” means that the cellulose acylate accounts for 55% by mass or more (preferably 70% by mass or more, and more preferably 80% by mass or more) of the polymer component.

As a raw material of the film production, it is preferable that a cellulose acylate particle is used. It is preferable that 90% by mass or more of the used particle has a particle size of from 0.5 to 5 mm. Also, it is preferable that 50% by mass or more of the used particle has a particle size of from 1 to 4 mm. It is preferable that the cellulose acylate particle has a shape close to a sphere as far as possible.

The polymerization degree of the cellulose acylate which is preferably used in the invention is preferably from 200 to 700, more preferably from 250 to 550, further preferably from 250 to 400, and especially preferably from 250 to 350 in terms of a viscosity average polymerization degree. The average polymerization degree can be measured by an intrinsic viscosity method proposed by Uda, et al. (Kazuo Uda and Hideo Saito, Jour of Soc. of Textile and Cellulose Industry Japan, Vol. 18, No. 1, pages 105-120, 1962). Furthermore, the details are described in JP-A-9-95538.

When a low molecular component is removed, the average molecular weight (polymerization degree) of the cellulose acylate is high. However, such cellulose acylate is useful because it is lower in viscosity than the usual cellulose acylate. The cellulose acylate with a less low molecular component can be obtained by removing the low molecular component from cellulose acylate as synthesized by a usual method. The removal of a low molecular component can be carried out by washing the cellulose acylate with an appropriate solvent. When the cellulose acylate with a less low molecular component is produced, it is preferable that the amount of the sulfuric acid catalyst in the acetylation reaction is adjusted at from 0.5 to 25 parts by mass based on 100 parts by mass of the cellulose. By making the amount of the sulfuric acid catalyst fall within the foregoing range, it is possible to synthesize cellulose acylate which is also favorable from the standpoint of molecular weight distribution (uniform molecular weight distribution).

When used at the production of the cellulose acylate film of the invention, the water content of the cellulose acylate is preferably not more than 2% by mass, more preferably not more than 1% by mass, and especially preferably not more than 0.7% by mass. In general, it is known that the cellulose acylate contains water in an amount of from 2.5 to 5% by mass. In the invention, in order to regulate the water content of the cellulose acylate at this range, it is necessary to dry the cellulose acylate. However, its method is not particularly limited so far as the targeted water content is obtained.

With respect to such cellulose acylate of the invention, its raw material cotton and synthesis method are described in detail on pages 7 to 12 of Journal of Technical Disclosure, No. 200-1745, issued Mar. 15, 2001 by Japan Institute of Invention and Innovation.

Examples of the raw material cellulose of the cellulose acylate which is used in the invention include cotton linter and wood pulps (for example, broad-leafed pulps and coniferous pulps), and cellulose acylate obtained from any of these raw material celluloses can be used. A mixture thereof may be used as the case may be. These raw material celluloses are described in detail in, for example, Course of Plastic Materials (17): Cellulose Resins, written by Marusawa and Uda and published by The Nikkan Kogyo Shimbun, Ltd. (1970) and Journal of Technical Disclosure, No. 200-1745 (pages 7 to 8). These materials can be used, but the invention is not particularly limited thereto with respect to the cellulose acylate film of the invention.

So far as the cellulose acylate of the invention falls within the foregoing ranges regarding the substituent, substitution degree, polymerization degree and molecular weight distribution and so on, the cellulose acylate can be used singly or in admixture of two or more kinds thereof.

(Substitution Degree of Cellulose Acylate)

The cellulose acylate of the invention is one in which a hydroxyl group of cellulose is acylated, and with respect to its substitution degree, any of from an acetyl group in which the number of carbon atoms of the acyl group is 2 to one in which the number of carbon atoms of the acyl group is 22 can be used. In the cellulose acylate of the invention, the substitution degree on the hydroxyl group of cellulose is not particularly limited. The substitution degree can be obtained by measuring a degree of bonding of acetic acid and/or a fatty acid having from 3 to 22 carbon atoms which is substituted on the hydroxyl group of cellulose and performing the calculation. The measurement method can be carried out in conformity with ASTM D-817-91.

The cellulose acylate which is used in the invention is preferably cellulose acylate having an acetylation degree of 2.0 or more and not more than 2.99. The acetylation degree is more preferably 2.5 or more and not more than 2.96.

A substitution ratio by the hydroxyl group at the 6-position of a glucose unit with an acyl group as represented by the following numerical expression (11) is preferably 0.31 or more, and it is more preferable that cellulose acetate having a total substitution degree of not more than 2.85 is used.

(Substitution ratio at the 6-position)=(Substitution degree at the 6-position)/[(Substitution degree at the 2-position)+(Substitution degree at the 3-position)+(Substitution degree at the 6-position)] Numerical Expression (11)

Furthermore, another preferred cellulose acylate which can be used in the invention is one having an acylation degree of 2.0 or more and not more than 2.90 and having two or more kinds of acyl groups. The acyl group preferably has from 2 to 6 carbon atoms, and an acetyl group, a propionyl group and a butyryl group are more preferably used. When the cellulose acylate film of the invention has an acetyl group and an acyl group other the acetyl group, the substitution degree of the acetyl group is preferably less than 2.8, and more preferably less than 2.7.

By adjusting the acetylation degree of the cellulose acylate, a gel point of a dope can be adjusted. In the case of a dope having cellulose acylate dissolved in a methylene chloride/alcohol mixed solvent, the gel point of the dope can be lowered by increasing the acylation degree.

### [Production of Cellulose Acylate Film]

The process for producing the polymer film of the invention includes casting a dope containing a polymer and a solvent on a support, drying, stripping off from the support and stretching the stripped-off film. In the production process, the content of the residual solvent at the start of stretching as represented by the following numerical expression (8) is 20% or more and not more than 140%, and a stretching rate is 5%/min or more and not more than 100%/min:

[Content of residual solvent(% by mass)]=100×{[Film mass(g)]−[Film mass(g)after drying at 120° C. for 2 hours]}/[Film mass(g)after drying at 120° C. for 2 hours] Numerical Expression (8)

The content of the residual solvent is obtained by cutting out a film with an area of about 5 cm×10 cm, measuring the film mass, drying at 120° C. for 2 hours, again measuring the mass and performing the calculation according to the foregoing numerical expression (8).

The content of the residual solvent is preferably 20% or more and not more than 100%, and more preferably 30% or more and not more than 80%.

By making the content of the residual solvent fall within the foregoing range, a difference in degree of orientation between the film surface and the film inside can be made large.

In the cellulose acylate film of the invention, in casting a dope containing a polymer and a solvent on a support, drying, stripping off from the support and stretching the stripped-off film, the degree of out-of-plane can be controlled by the progress degree of gelation and the content of the residual solvent.

That is, in the drying step, where the degree of gelation is small or the gelation does not occur, there is a tendency that a film in which the distribution in degree of out-of-plane orientation after stretching is the direction A, namely the degree of out-of-plane orientation of the film surface is higher than that in the film inside is obtained.

This is because the diffusion of the solvent molecule is rate-determining and the solvent concentration on the film surface is lower than the solvent concentration in the film inside, and therefore, the film surface is higher in elastic modulus and larger in stretching stress than the film inside.

On the other hand, when gelation occurs, the orientation of a polymer molecular chain is inhibited. In the drying step, the diffusion is rate-determining and the film surface is higher in polymer concentration than the film inside, and therefore, the gelation on the film surface proceeds faster than the film inside.

Accordingly, when the film in which the gelation has proceeded is stretched, there is a tendency that a film in which the degree of out-of-plane orientation of the film inside is higher than that on the film surface (distribution B) is obtained.

In the invention, the easiness of gelation at the drying is evaluated in terms of a gel point of the dope. In the invention, the gel point of the dope is defined as a temperature at which when a viscoelasticity is measured by a rheometer while decreasing the measurement temperature from a high-temperature side to a low-temperature side of 30° C. to −15° C., a value of storage elastic modulus and a value of loss elastic modulus are equal to each other.

In the invention, in order to produce a poly film having the distribution A, it is preferable that a dope having a gel point of no higher than −15° C. or not having a gel point is cast, stripped off and started to stretch in the content of the residual solvent at the start of stretching of 20% or more and not more than 140%. On that occasion, the content of the residual solvent is more preferably 20% or more and not more than 100%, and most preferably 30% or more and not more than 80%.

The “gel point of no higher than −15° C.” as referred to herein means the case where when the gel point is lower than −15° C., or when a viscoelasticity is measured by a rheometer while decreasing the measurement temperature from a high-temperature side to a low-temperature side of 30° C. to −15° C., the gel point is not observed.

In the invention, the polymer film having the distribution A can be more effectively produced by using a good solvent A against a polymer having a low boiling point and a poor solvent B against a polymer having a high boiling point and adjusting a correlation between volatilization rate and diffusion rate of a solvent in the film at the drying of the support after casting.

That is, in the step of casting a dope composed of a mixed solvent having a higher ratio of the poor solvent than the azeotropic ratio on a support and drying it on the support, when the volatilization rate of the solvent from the film surface is sufficiently smaller than the diffusion rate of the solvent in the film, following the progress of drying, the ratio of the poor solvent in the mixed solvent becomes higher on the film support surface side in the film thickness direction. In the polymer, a mutual action among polymers in the poor solvent is stronger than that in the good solvent, and therefore, a film having a high degree of out-of-plane orientation of the polymer on the support surface side is obtained.

In addition to the above, by adding an additive having low affinity with the polymer and having a low solubility in the mixed solvent in the polymer, the degree of orientation of the polymer on the support surface side can be further increased relatively. The concentration distribution of the foregoing additive in the film thickness direction becomes high with the progress of drying of the film on the support surface side having a high solvent concentration. Since the foregoing additive has low affinity with the polymer, the polymers are easy to mutually act each other in a region where the concentration of the foregoing additive is high. As a result, the degree of out-of-plane orientation of the polymer becomes high.

Also, in the production process of the invention, in order to produce a polymer film having the distribution B, it is preferable that a dope having a gel point of −10° C. or higher is cast on a support, dried and stripped off from the support and that the stripped-off film is started to stretch in the content of the residual solvent as represented by the foregoing numerical expression (8) is 20% or more and not more than 140%. On that occasion, the content of the residual solvent is more preferably 30% or more and not more than 120%, and most preferably 40% or more and not more than 100%.

The production process of the invention is hereunder described in detail.

### (Organic Solvent of Cellulose Acylate Solution)

In the invention, the film is produced by using a solution (dope) having cellulose acylate dissolved in an organic solvent. The organic solvent which is preferably used as a prime solvent of the invention is preferably a solvent selected from esters, ketones and ethers each having from 3 to 12 carbon atoms and halogenated hydrocarbons having from 1 to 7 carbon atoms. The ester, the ketone or the ether may have a cyclic structure. A compound having two or more functional groups of an ester, a ketone or an ether (namely, —O—, —CO— or —COO—) can also be used as the prime solvent. The solvent may have other functional group such as an alcoholic hydroxyl group. In the case of a prime solvent having two or more kinds of functional groups, the number of carbon atoms may fall within the foregoing range of a compound having any one of the foregoing functional groups.

For the cellulose acylate film of the invention, it is preferable that a mixture of a chlorine based halogenated hydrocarbon as a prime solvent (good solvent) and at least one kind of a monohydric alcohol having not more than 10 carbon atoms as a poor solvent is used. By changing the number of carbon atoms of the alcohol to be mixed and its mixing ratio to the prime solvent, the gel point of the dope can be adjusted.

Furthermore, by using a dope dissolved in a mixed solvent in which a boiling point of the good solvent is higher than that of the poor solvent and the concentration of the poor solvent is higher than the azeotropic ratio and performing drying after casting the dope on a support under a condition that the volatilization rate of the solvent from the film surface is smaller than the diffusion rate of the solvent in the film inside, the ratio of the poor solvent on the support surface side can be more likely increased, and the degree of out-of-plane orientation of the cellulose acylate can be adjusted.

In the case of a dope using methylene chloride as a prime solvent relative to the cellulose acylate, in order to obtain a dope having a gel point of no higher than −15° C., it is preferable that a composition of the alcohol relative to the prime solvent is satisfied with the relationship represented by the following numerical expression (12).

0≦Σ(Ri·Ci)≦25 Numerical Expression (12)

Here, Ri represents the number of carbon atoms of the i-th alcohol; Ci represents % by weight of the i-th alcohol relative to the whole of solvents; and Σ means that the total sum of all of alcohols added in the dope is taken.

The foregoing numerical expression (12) is more preferably the following numerical expression (12-1), and most preferably the following numerical expression (12-2).

0≦Σ(Ri·Ci)≦20 Numerical Expression (12-1)

0≦Σ(Ri·Ci)≦15 Numerical Expression (12-2)

Also, in the case where the prime solvent is methylene chloride, in order to obtain a dope having a gel point of −10° C. or higher, it is preferable that a composition of the alcohol relative to the prime solvent is satisfied with the relationship represented by the following numerical expression (13).

15≦Σ(Ri·Ci)≦45 Numerical Expression (13)

Here, Ri represents the number of carbon atoms of the i-th alcohol; Ci represents % by weight of the i-th alcohol relative to the whole of solvents; and Σ means that the total sum of all of alcohols added in the dope is taken.

The foregoing numerical expression (13) is more preferably the following numerical expression (13-1), and most preferably the following numerical expression (13-2).

20≦Σ(Ri·Ci)≦40 Numerical Expression (13-1)

25≦Σ(Ri·Ci)≦35 Numerical Expression (13-2)

### (Casting)

Examples of the casting method of a solution include a method in which a prepared dope is uniformly extruded onto a metal support from a pressure die; a method by a doctor blade in which the thickness of a dope having been once cast on a metal support is adjusted by a blade; and a method by a reverse roll coater in which the thickness of a dope having been once cast on a metal support is adjusted by a reversely rotating roll. Of these, a method by a pressure die is preferable. Besides the methods as exemplified above, various conventionally known methods for casting and fabricating a cellulose triacetate solution can be employed. By setting up each condition while taking into consideration a difference in boiling point of a solvent to be used or the like, the same effects as the contents described in the respective patent documents are obtained. As the metal support running in an endless manner, which is used for producing the cellulose acylate film of the invention, a drum in which a surface thereof is mirror-finished by chromium plating or a stainless steel belt (the belt may be called a band) which is mirror-finished by surface polishing is useful. The pressure die which is used for the production of the cellulose acylate film of the invention may be set up in the number of one or two or more in an upper part of the metal support. The number of the pressure die is preferably one or two. In the case where two or more pressure dies are set up, the amount of the dope to be cast may be divided in various proportions for the respective dies. Also, the dope may be sent to the dies in the respective proportions from plural precision metering gear pumps. The temperature of the cellulose acylate solution which is used for casting is preferably from −10 to 55° C., and more preferably from 25 to 50° C. In that case, the temperature may be identical in all of the steps, or the temperature may be different in each place of the steps. In the case where the temperature is different, it would be better that the temperature just before casting is the desired temperature.

The drying method in the solvent casting method is described in U.S. Pat. Nos. 2,336,310, 2,367,603, 2,492,078, 2,492,977, 2,492,978, 2,607,704, 2,739,069 and 2,739,070, U.K. Patents Nos. 640,731 and 736,892, JP-B-45-4554, JP-B-49-56214, JP-A-60-176834, JP-A-60-203430, and JP-A-62-115035. The drying on the band or drum can be performed by ventilating an inert gas such as air and nitrogen.

In the invention, it is preferable that the drying on the support is carried out in a state that the volatilization rate of the solvent from the film surface is smaller than the diffusion rate of the solvent in the film inside.

So far as the drying is carried out in such a state, when a dope obtained by dissolving the polymer in a mixed solvent of a good solvent having a low boiling point and a poor solvent having a high boiling point such that the ratio of the poor solvent is higher than the azeotropic ratio, the drying step can be realized more likely on the support surface side in a state that the concentration of the poor solvent is high, and the degree of out-of-plane orientation of the polymer on the support surface side can be made large.

In the invention, when the content of the residual solvent represented by the following numerical expression (8) is 160%, a ratio of the poor solvent to the good solvent is preferably 1.1 times or more, and more preferably 1.2 times or more of a ratio of the poor solvent to the good solvent in the dope.

[Content of residual solvent(% by mass)]=100×{[Film mass(g)]−[Film mass(g)after drying at 120° C. for 2 hours]}/[Film mass(g)after drying at 120° C. for 2 hours] Numerical Expression (8)

In the invention, the ratio of the poor solvent and the good solvent in the dope or film can be determined by diluting the film or dope with other good solvent than the good solvent to be used in the dope and analyzing by gas chromatography.

The formation of a film can also be carried out by casting two or more layers by using the prepared cellulose acylate solution (dope). In that case, it is preferable that the cellulose acylate film is prepared by the solvent casting method. The dope is cast on the drum or band, and the solvent is vaporized to form a film. It is preferable that the concentration of the dope before casting is adjusted in the range of from 10 to 40% in terms of a solids content. It is preferable that the surface of the drum or band is mirror-finished.

In the case of casting the cellulose acylate solution of two or more plural layers, plural cellulose acylate solutions can be cast. A film may be prepared while casting each cellulose acylate-containing solution from plural casting nozzles provided at intervals in the movement direction of the support and stacking. For example, methods described in JP-A-61-158414, JP-A-1-122419 and JP-A-11-198285 can be employed. Also, the formation of a film can also be carried out by casting the cellulose acylate solution from two casting nozzles. For example, methods described in JP-B-60-27562, JP-A-61-94724, JP-A-61-947245, JP-A-61-104813, JP-A-61-158413 and JP-A-6-134933 can be employed. Furthermore, a casting method described in JP-A-56-162617, in which a flow of a high-viscosity cellulose acylate solution is encompassed by a low-viscosity cellulose acylate solution, and the high-viscosity and low-viscosity cellulose acylate solutions are simultaneously extruded can also be employed.

Also, a film can be prepared by using two casting nozzles, stripping off a film formed on a support by a first casting nozzle and then subjecting the side coming into contact with the support surface of the film to second casting. For example, a method described in JP-B-44-20235 can be exemplified.

With respect to the cellulose acylate solution to be cast, the same solution may be used, or different cellulose solutions may be used. For the purpose of making plural cellulose acylate layers have a function, a cellulose acylate solution corresponding to each function may be extruded from each casting nozzle. Furthermore, the cellulose acylate solution which is used in the invention can be cast simultaneously with other functional layer (for example, an adhesive layer, a dye layer, an antistatic layer, an anti-halation layer, an ultraviolet ray absorbing layer and a polarizing layer).

In conventional single-layer solutions, in order to bring the film with a necessary thickness, it is required to extrude a high-viscosity cellulose acylate solution in a high concentration. In that case, there was often encountered a problem that the stability of the cellulose acylate solution is so poor that solids are generated, thereby causing a spitting fault or inferiority in flatness. As a method for solving this problem, by casting plural cellulose acylate solutions from casting nozzles, high-viscosity solutions can be extruded onto the support, and a film having improved flatness and excellent surface properties can be prepared. Also, by using concentrated cellulose acylate solutions, a reduction of a drying load can be achieved, and the production speed of the film can be enhanced.

### [Stretching Treatment]

In the process for producing the cellulose acylate film of the invention, the cellulose acylate film is subjected to a stretching treatment. It is possible to impart a desired retardation to the cellulose acylate film by the stretching treatment. With respect to the stretching direction of the cellulose acylate film, all of a width direction and a longitudinal direction are preferable, and a width direction is especially preferable.

A method for achieving stretching in a width direction is described in, for example, JP-A-62-115035, JP-A-4-152125, JP-A-4-284211, JP-A-4-298310 and JP-A-11-48271. In the case of stretching in a longitudinal direction, for example, the film is stretched by adjusting conveyance rollers of the film to make a winding-up speed of the film faster than a stripping-off speed of the film. In the case of stretching in a width direction, the film can also be stretched by conveying the film while holding the width of the film by a tenter and gradually widening the width of the tenter. After drying the film, the film can also be stretched by using a stretching machine (preferably uniaxially stretched by using a long stretching machine).

A stretching ratio of the cellulose acylate film of the invention is preferably 5% or more and not more than 200%, and more preferably 10% or more and not more than 100%.

A stretching rate of the cellulose acylate film of the invention is preferably 5%/min or more and not more than 100%/min, more preferably 10%/min or more and not more than 70%/min, and most preferably 10%/min or more and not more than 50%/min.

When the stretching rate is small, a film having large distribution in degree of out-of-plane orientation in the thickness direction of the film can be obtained. On the other hand, where the stretching rate is too small, the stretching unevenness of the film becomes large, thereby causing a problem that an in-plane retardation (Re) of the film becomes non-uniform.

### [Additives]

It is preferable that the cellulose acylate film of the invention contains additives such as an orientation adjusting agent, a plasticizer, a retardation expressing agent, a matting agent fine particle and an ultraviolet absorber.

### (Orientation Adjusting Agent)

In the cellulose acylate film of the invention, it is preferred to use an orientation adjusting agent. The “orientation adjusting agent” as referred to in the invention refers to one having a function to adjust the degree of orientation of a cellulose acylate molecular chain.

The orientation adjusting agent of the invention is preferably one having a low solubility in the dope solvent and low affinity with the cellulose acylate. By using such an orientation adjusting agent, it becomes possible to obtain a film in which the degree of out-of-plane orientation in the film thickness direction is larger on the support surface side.

This is estimated to be caused due to the following mechanism.

At the initial stage of drying step, when the drying is performed under the condition that the volatilization rate of the solvent from the film surface is larger than the diffusion rate of the solvent in the film inside, the solvent concentration distribution in the film is lower in the vicinity of the interface with air, whereas it is higher in the vicinity of the support side. When the concentration of the orientation adjusting agent is a saturated solubility or more, the orientation adjusting agent moves into the support side where the solvent concentration is high, and the concentration of the orientation adjusting agent has high distribution on the support surface side. When an affinity between the orientation adjusting agent and the cellulose acylate film is low, a mutual action among the cellulose acylates easily occurs, and the degree of out-of-plane orientation of cellulose acylate becomes high.

The addition amount of the orientation adjusting agent of the invention relative to methylene chloride/methanol (70/30 by volume) is preferably 0.1% by mass or more and not more than 40% by mass, and more preferably 1% by mass or more and not more than 35% by mass.

Also, the affinity of the additive with the cellulose acylate can be evaluated by a change in a glass transition temperature of the film caused due to the addition of the additive. A difference in the glass transition temperature between a film having the orientation adjusting agent of the invention added therein and a film not having the orientation adjusting agent of the invention added therein is preferably no higher than 2.5° C., and more preferably no higher than 2.0° C. per 1% by mass of the addition amount. The smaller the glass transition temperature due to the presence or absence of the additive, the lower the affinity with the polymer is.

The glass transition temperature of the film can be determined by measuring dynamic viscoelasticity. That is, a film sample is humidified at 25° C. and at a relative humidity of 60% for 2 hours or more and then measured at a grasping distance of 20 mm and a temperature rise rate of 2° C./min in the measurement temperature range of from 30° C. to 200° C. at a frequency of 1 Hz by a dynamic viscoelasticity meter (Vibron DVA-225, manufactured by IT Keisoku Seigyo Co., Ltd.). The resulting data are then plotted with a storage elastic modulus as the logarithmic ordinate and a temperature (° C.) as the linear abscissa. A straight line 1 indicating a sudden reduction of storage elastic modulus developed when the sample shows transition from a solid region to a glass transition region is drawn in the solid material region. A straight line 2 is drawn in the glass transition region. A point of crossing of the straight line 1 and the straight line 2 is defined as a glass transition temperature Tg.

As the orientation adjusting agent of the invention, a compound having at least two ester groups and having a log P value (octanol-water distribution coefficient) of 6 or more and not more than 14 is preferable. The log P value is more preferably 7 or more and not more than 13. When the log P value is too low, the affinity with the cellulose acylate is too high, whereby the degree of out-of-plane orientation on the support surface side in the film thickness direction is low. On the other hand, when the log P value is too high, the affinity with the cellulose acylate is too low, whereby a fault in surface properties such as bleedout is easily caused, and therefore, such is not preferable.

The measurement of the log P value can be carried out by a flask osmosis method described in JIS Z7260-107 (2000). The log P value can be estimated by a computational chemistry method or an empirical method rather than the actual measurement. Examples of the calculation method which can be preferably employed include a Crippen's fragmentation method (J. Chem. Inf. Comput. Sci., 27, 21 (1987)), a Viswanadhan's fragmentation method (J. Chem. Inf. Comput. Sci., 29, 163 (1989)) and a Broto's fragmentation method (Eur. J. Med. Chem.—Chim. Theor., 19, 71 (1984)). Of these, a Crippen's fragmentation method (J. Chem. Inf. Comput. Sci., 27, 21 (1987)) is more preferable. In the case where the log P value of a certain compound varies with the measurement method or the calculation method, it is desired to employ the Crippen's fragmentation method to judge whether or not the compound falls within the range of the invention.

A compound represented by the following general formula (1) can be preferably used as the orientation adjusting agent of the invention.

Ar¹-L²-X-L³-Ar² General Formula (1)

In the foregoing general formula (1), Ar¹ and Ar² each independently represents an aromatic group.

In this specification, the aromatic group includes an aryl group (aromatic hydrocarbon group), a substituted aryl group, an aromatic heterocyclic group and a substituted aromatic heterocyclic group.

The aryl group and the substituted aryl group are more preferable than the aromatic heterocyclic group and the substituted aromatic heterocyclic group. The hetero ring of the aromatic heterocyclic group is generally unsaturated. The aromatic hetero ring is preferably a 5-membered ring, a 6-membered ring or a 7-membered ring, and more preferably 5-membered ring or a 6-membered ring. The aromatic hetero ring generally has a maximum number of double bonds. As the hetero atom, a nitrogen atom, an oxygen atom and a sulfur atom are preferable, with a nitrogen atom and a sulfur atom being more preferable.

Examples of the aromatic ring of the aromatic group include a benzene ring, a furan ring, a thiophene ring, a pyrrole ring, an oxazole ring, a thiazole ring, an imidazole ring, a triazole ring, a pyridine ring, a pyrimidine ring and a pyrazine ring. Of these, a benzene ring is especially preferable.

Examples of the substituent of the substituted aryl group and the substituted aromatic heterocyclic ring include a halogen atom (for example, F, Cl, Br and I), a hydroxyl group, a carboxyl group, a cyano group, an amino group, an alkylamino group (for example, a methylamino group, an ethylamino group, a butylamino group and a dimethylamino group), a nitro group, a sulfo group, a carbamoyl group, an alkylcarbamoyl group (for example, an N-methylcarbamoyl group, an N-ethylcarbamoyl group and an N,N-dimethylcarbamoyl group), a sulfamoyl group, an alkylsulfamoyl group (for example, N-methylsulfamoyl group, an N-ethylsulfamoyl group and an N,N-dimethylsulfamoyl group), a ureido group, an alkylureido group (for example, an N-methylureido group, an N,N-dimethylureido group and an N,N,N′-trimethylureido group), an alkyl group (for example, a methyl group, an ethyl group, a propyl group, a butyl group, a pentyl group, a heptyl group, an octyl group, an isopropyl group, a sec-butyl group, a t-amyl group, a cyclohexyl group and a cyclopentyl group), an alkenyl group (for example, a vinyl group, an allyl group and a hexenyl group), an alkynyl group (for example, an ethynyl group and a butynyl group), an acyl group (for example, a formyl group, an acetyl group, a butyryl group, a hexanoyl group and a lauryl group), an acyloxy group (for example, an acetoxy group, a butyryloxy group, a hexanoyloxy group and a lauryloxy group), an alkoxy group (for example, a methoxy group, an ethoxy group, a propoxy group, a butoxy group, a benzyloxy group, a heptyloxy group and an octyloxy group), an aryloxy group (for example, a phenoxy group), an alkoxycarbonyl group (for example, a methoxycarbonyl group, an ethoxycarbonyl group, a propoxycarbonyl group, a butoxycarbonyl group, a pentyloxycarbonyl group and a heptyloxycarbonyl group), an aryloxycarbonyl group (for example, a phenoxycarbonyl group), an alkoxycarbonylamino group (for example, a butoxycarbinylamino group and a hexyloxycarbonylamino group), an alkylthio group, (for example, a methylthio group, an ethylthio group, a propylthio group, a butylthio group, a pentylthio group, a heptylthio group and an octylthio group), an arylthio group (for example, a phenylthio group), an alkylsulfonyl group (for example, a methylsulfonyl group, an ethylsulfonyl group, a propylsulfonyl group, a butylsulfonyl group, a pentylsulfonyl group, a heptylsulfonyl group and an octylsulfonyl group), an amido group (for example, an acetamido group, a butylamido group, a hexylamido group and a laruylamido group) and a non-aromatic heterocyclic group (for example, a morpholino group and a pyradinyl group).

As the substituent of the substituted aryl group and the substituted aromatic heterocyclic group, a halogen atom, a cyano group, a carboxyl group, a hydroxyl group, an amino group, an alkyl-substituted amino group, an acyl group, an acyloxy group, an amido group, an alkoxycarbonyl group, an alkoxy group, an alkylthio group and an alkyl group are preferable.

The alkyl moiety and the alkyl group of the alkylamino group, the alkoxycarbonyl group, the alkoxy group and the alkylthio group may further have a substituent. Examples of the substituent of the alkyl moiety and the alkyl group include a halogen atom, hydroxyl, carboxyl, cyano, amino, an alkylamino group, nitro, sulfo, carbamoyl, an alkylcarbamoyl group, sulfamoyl, an alkylsulfamoyl group, ureido, an alkylureido group, an alkenyl group, an alkynyl group, an acyl group, an acyloxy group, an acylamino group, an alkoxy group, an aryloxy group, an alkoxycarbonyl group, an aryloxycarbonyl group, an alkoxycarbonylamino group, an alkylthio group, an arylthio group, an alkylsulfonyl group, an amido group and a non-aromatic heterocyclic group. As the substituent of the alkyl moiety and the alkyl group, a halogen atom, hydroxyl, amino, an alkylamino group, an acyl group, an acyloxy group, an acylamino group, an alkoxycarbonyl group and an alkoxy group are preferable.

In the general formula (I), L² and L³ each independently represents a divalent connecting group selected from —O—CO—, —CO—O— and a combination thereof.

In the general formula (1), X represents 1,4-cyclohexylene, vinylene or ethynylene.

Specific examples of the compound represented by the general formula (1) are given as follows.

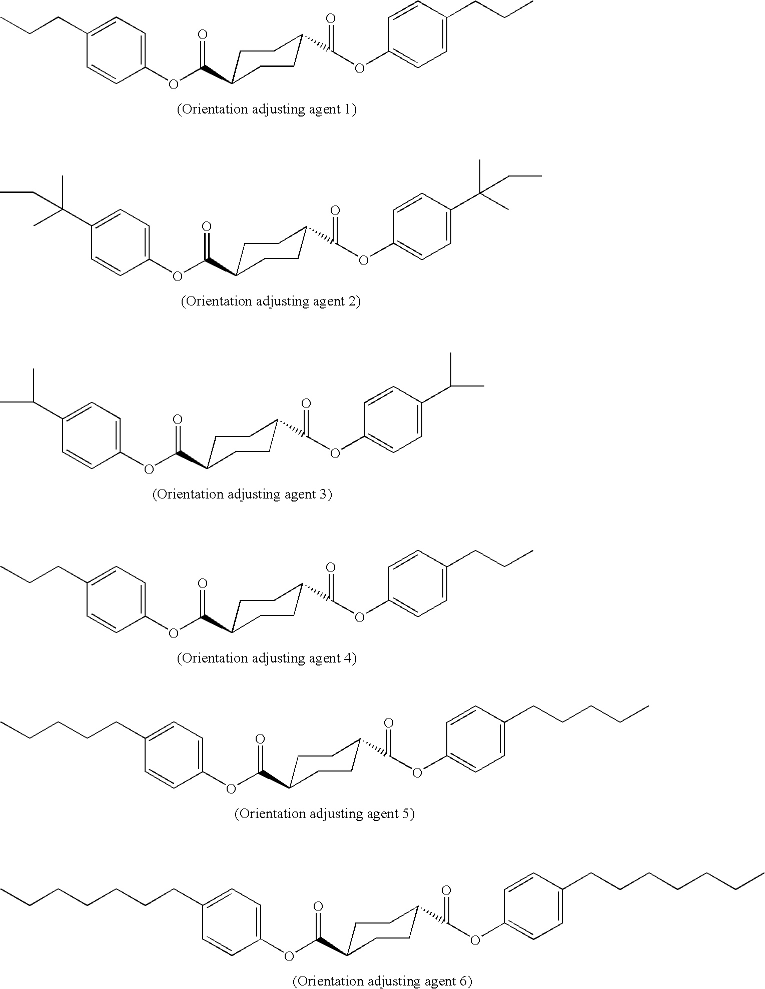

The addition amount of the orientation adjusting agent of the invention is preferably from 0.1 to 20% by mass, more preferably from 0.5 to 15% by mass, and especially preferably from 1 to 10% by mass relative to the polymer. In the case where two or more kinds of the orientation adjusting agent are used, it is preferable that the total sum thereof is satisfied with the foregoing range.

The orientation adjusting agent of the invention may be previously added when a mixed solution of the cellulose acylate is prepared. Alternatively, a dope of the cellulose acylate is previously prepared, and the orientation adjusting agent may be added at any point of time until casting. In the latter case, in order to achieve the in-line addition and mixing of a dope solution of the cellulose acylate dissolved in a solvent and a solution having the orientation adjusting agent and a small amount of the cellulose acylate dissolved therein, an in-like mixer such as a static mixer (manufactured by Toray Engineering Co., Ltd.) and SWJ (Toray static in-pipe mixer; Hi-Mixer) and the like are preferably used. In the orientation adjusting agent to be added later, a matting agent may be simultaneously mixed, or additives such as a retardation controlling agent, a plasticizer, an anti-degradation agent and a separation accelerator may be mixed. In the case of using an in-line mixer, it is preferable that concentration and dissolution are performed under a high pressure. A pressure container is not particularly limited, and any pressure container is employable so far as it is able to withstand against a prescribed pressure and it is able to achieve heating and stirring under a pressure. In addition, the pressure container is properly provided with a measuring instrument such as a pressure gauge and a thermometer. The pressurization may be carried out by a method for injecting an inert gas such as a nitrogen gas or by increasing a vapor pressure of a solvent by heating. It is preferable that the heating is carried out from the outside, and for example, a jacket type is preferable because the temperature control is easy. The heating temperature by the addition of a solvent is preferably a temperature in the range of a boiling point of the used solvent or higher and where the solvent does not boil. It is favorable that the heating temperature is, for example, set up in the range of from 30 to 150° C. Also, the pressure is adjusted such that the solvent does not boil at a set temperature. After the dissolution, the resulting mixture is taken out while cooling from the container or discharged from the container by a pump or the like and cooled by a heat exchanger or the like, followed by providing for the fabrication. At that time, with respect to the cooling temperature, the mixture may be cooled to the ordinary temperature. However, a method in which the mixture is cooled to a temperature of from 5 to 10° C. lower than the boiling point and subjected to casing at that temperature is preferable because the dope viscosity can be reduced.

### (Retardation Expressing Agent)

As the retardation expressing agent, compounds described in JP-A-2001-166144, JP-A-2002-363343, JP-A-2003-344655, JP-A-2005-272685 and so on can be preferably used.

### (Ultraviolet Absorber)

The cellulose acylate film of the invention may contain an ultraviolet absorber.

Examples of the ultraviolet absorber include hydroxybenzophenone based compounds, benzotriazole based compounds, salicylic ester based compounds, benzophenone based compounds, cyanoacrylate based compounds and nickel complex salt based compounds. Of these, benzotriazole based compounds which are less in coloration are preferable. Also, ultraviolet absorbers described in JP-A-10-182621 and JP-A-8-337574 and high molecular ultraviolet absorbers described in JP-A-6-148430 are preferably used. In the case where the cellulose acylate of the invention is used as a protective film of a polarizing plate, as the ultraviolet absorber, ones having an excellent absorbing ability of ultraviolet rays having a wavelength of not more than 370 nm are preferable from the viewpoint of preventing degradation of a polarizer or a liquid crystal, and ones which are less in absorption of visible light having a wavelength of 400 nm or more are preferable from the view point of liquid crystal display properties.

Specific examples of the benzotriazole based ultraviolet absorber which is useful in the invention include 2-(2′-hydroxy-5′-methylphenyl)benzotriazole, 2-(2′-hydroxy-3′,5′-di-t-phenyl)benzotriazole, 2-(2′-hydroxy-3′-t-butyl-5′-methylphenyl)benzotriazole, 2-(2′-hydroxy-3′,5′-di-t-butylphenyl)-5-chlorobenzotriazole, 2-[2′-hydroxy-3′-(3″,4″,5″,6″-tetrahydrophthalimidomethyl)-5′-methylphenyl]benzotriazole, 2,2-methylenebis-[4-(1,1,3,3-tetramethylbutyl)-6-(2H-benzotriazol-2-yl)-phenol], 2-(2′-hydroxy-3′-t-butyl-5′-methylphenyl)-5-chlorobenzotriazole, 2-(2H-benzotriazol-2-yl)-6-(straight and side chained dodecyl)-4-methylphenol, and a mixture of octyl-3-[3-t-butyl-4-hydroxy-5-(chloro-2H-benzotriazol-2-yl)phenyl]propionate and 2-ethylhexyl-3-[3-t-butyl-4-hydroxy-5-(5-chloro-2H-benzotriazol-2-yl)phenyl]propionate. However, it should not be construed that the invention is limited thereto.

TINUVIN 109, TINUVIN 171, TINUVIN 326 and TINUVIN 328 (all of which are manufactured by Ciba Specialty Chemicals) can also be preferably used as commercially available products.

### (Plasticizer)

It is preferable that the film of the invention contains a plasticizer. The plasticizer which can be used is not particularly limited. It is preferable that compounds which are more hydrophobic than the cellulose acylate are used singly or in combination. Examples thereof include phosphoric ester based compounds (for example, biphenyl phosphate, triphenyl phosphate, tricresyl phosphate, cresyl diphenyl phosphate, octyl diphenyl phosphate, diphenyl biphenyl phosphate, trioctyl phosphate and tributyl phosphate), phthalic ester based compounds (for example, diethyl phthalate, dimethoxyethyl phthalate, dimethyl phthalate, dioctyl phthalate, dibutyl phthalate and di-2-ethylhexyl phthalate), and glycolic ester based compounds (for example, triacetin, tributyrin, butylphthalylbutyl glycolate, ethylphthalylethyl glycolate, methylphthalylethyl glycolate and butylphthalylbutyl glycolate). The plasticizer may be used in combination of two or more kinds thereof as the need arises.

It is recommended that the additive which is added in the cellulose acylate film of the invention is added in an amount of from 0.1 to 30% by mass, preferably from 0.5 to 20% by mass, and more preferably from 1 to 15% by mass relative to the cellulose. When two or more kinds of the additives are used, it is preferable that the total sum thereof is satisfied with the foregoing range.

### (Matting Agent Fine Particle)

It is preferable that a fine particle is added as a matting agent in the cellulose acylate film which is preferably used in the invention. Examples of the fine particle which is used in the invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. With respect to the fine particle, one containing silicon is preferable in view of the matter that the turbidity is low, and silicon dioxide is especially preferable.

As the fine particle of silicon dioxide, one having an average particle size of primary particle of not more than 20 nm and an apparent specific gravity of 70 g/L or more is preferable. One having a small average particle size of primary particle as from 5 to 16 nm is more preferable because it is able to reduce the haze of the film. The apparent specific gravity is preferably from 90 to 200 g/L, and more preferably from 100 to 200 g/L. What the apparent specific gravity is large is preferable because a dispersion with a high concentration can be prepared, and the haze and the coagulated material are improved.

In the case where a silicon dioxide fine particle is used as the matting agent, its use amount is preferable from 0.01 to 0.3 parts by mass based on 100 parts by mass of the cellulose acylate-containing polymer component.

Such a fine particle usually forms a secondary particle having an average particle size of from 0.1 to 3.0 μm. The secondary particle exists as a coagulated material of the primary particle in the film and forms irregularities of from 0.1 to 3.0 μm on the film surface. The average particle size of the secondary particle is preferably 0.2 μm or more and not more than 1.5 μm, more preferably 0.4 μm or more and not more than 1.2 μm, and most preferably 0.6 μm or more and not more than 1.1 μm. When the average particle size is not more than 1.5 μm, the haze does not become excessively strong. Also, when it is 0.2 μm or more, an effect for preventing squeak is sufficiently exhibited, and therefore, such is preferable.

The primary or secondary particle size of the fine particle is defined in terms of a diameter of a circle which touches externally the particle upon observation of the particle in the film by a scanning electron microscope. Also, by changing the place and observing 200 particles, its average value is defined as an average particle size.

As the fine particle of silicon dioxide, commercially available products such as AEROSIL R972, R972V, R974, R812, 200, 200V, 300, R202, OX50 and TT600 (all of which are manufactured by Nippon Aerosil Co., Ltd.) can be used. The fine particle of zirconium oxide is commercially available as a trade name, for example, AEOSIL R976 and R811 (all of which are manufactured by Nippon Aerosil Co., Ltd.), and these products can be used.

Of these, AEROSIL 200V and AEROSIL R972V are especially preferable because they are a fine particle of silicon dioxide having an average particle size of primary particle of not more than 20 nm and an apparent specific gravity of 70 g/L or more and have a large effect for reducing a coefficient of friction while keeping a turbidity of the optical film low.

In the invention, in order to obtain a cellulose acylate film containing a particle having a small average particle size of secondary particle, some methods can be thought in preparing a dispersion of fine particle. For example, there is a method in which a fine particle dispersion having a solvent and a fine particle stirred and mixed therein is previously prepared, this fine particle dispersion is added in a small amount of a separately prepared cellulose acylate solution and stirred for dissolution, and the mixture is then mixed with the main cellulose acylate dope solution. This method is a preferred preparation method from the standpoints that the dispersibility of the silicon dioxide fine particle is good and that the silicon dioxide fine particle is further hardly recoagulated. Besides, there is a method in which a small amount of a cellulose ester is added in a solvent and stirred for dissolution, a fine particle is added thereto, the mixture is dispersed by a dispersing machine to form a fine particle addition solution, and this fine particle addition solution is thoroughly mixed with a dope solution in an in-line mixer. It should not be construed that the invention is limited to these methods. When the silicon dioxide fine particle is mixed and dispersed in a solvent or the like, the concentration of silicon oxide is preferably from 5 to 30% by mass, more preferably from 10 to 25% by mass, and most preferably from 15 to 20% by mass. What the dispersion concentration is high is preferable that the turbidity of the liquid relative to the addition amount is low, and the haze and the coagulated material are improved. The addition amount of the matting agent in the final dope solution of the cellulose acylate is preferably from 0.01 to 1.0 g, more preferably from 0.03 to 0.3 g, and most preferably from 0.08 to 0.16 g per 1 m².

As the solvent to be used, lower alcohols are exemplified. Preferred examples thereof include methyl alcohol, ethyl alcohol, propyl alcohol, isopropyl alcohol and butyl alcohol. Other solvents than the lower alcohol are not particularly limited. It is preferable that the solvent which is used at the fabrication of cellulose ester is used.

### [Various Characteristics of Cellulose Acylate Film]

### (Thickness of Cellulose Acylate Film)

The thickness of the cellulose acylate film of the invention is preferably 20 μm or more and not more than 100 μm, and more preferably 30 μm or more and not more than 90 μm.

### (Retardation of Film)

In this specification, Re (λ) and Rth (λ) represent an in-plane retardation and a retardation in the thickness direction at a wavelength λ, respectively. The Re (λ) is measured by making light having a wavelength of λ nm incident in a film normal direction in KOBRA 21ADH or WR (all of which are manufactured by Oji Scientific Instruments).

In the case where the film to be measured is represented by a uniaxial or biaxial refractive index ellipsoid, the Rth (λ) is calculated in the following manner.

With respect to the Rth (λ), the Re (λ) is measured in 6 points in total by forming an in-plane slow axis (judged by KOBRA 21ADH or WR) as an axis of tilt (rotating axis) (in the case where no slow axis exists, an arbitrary direction in the plane is formed as a rotating axis) and making light having a wavelength of λ nm incident from an inclined direction at a step of every 10° to 50° on one side from a normal direction to the film normal direction, and the Rth is calculated by KOBRA 21ADH or WR on the basis of a measured retardation value, a hypothesized value of average refractive index and an inputted film thickness value.

In the foregoing, in the case of a film having a direction where a retardation value is zero at a certain tilt angle from the normal direction while forming the in-plane slow axis as a rotating axis, a retardation value at a title angle larger than this tilt angle is changed with a negative symbol, and the Rth is calculated by KOBRA 21ADH or WR.

The Rth can also be calculated according to the following numerical expressions (21) and (22) by forming the slow axis as an axis of tilt (rotating axis) (in the case where no slow axis exists, an arbitrary direction in the plane is formed as a rotating axis), measuring retardation values from two arbitrary inclined direction and making the measured values hypothesized value of average refractive index and an inputted film thickness value as a basis.

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} \qquad Numerical Expression ( 21 )$$

In the numerical expression (21), Re (θ) represents a retardation value in a direction inclined at an angle of θ from the normal direction.

In the numerical expression (21), nx represents a refractive index in the slow axis direction in the plane; ny represents a refractive index in a direction perpendicular to nx; nz represents a refractive index in a direction perpendicular to nx and ny; and d represents a thickness of the film.

$$Rth = [ \frac{nx + ny}{2} - nz ] \times d \qquad Numerical Expression ( 22 )$$

In the case of a film which cannot be represented by a uniaxial or biaxial refractive index ellipsoid, namely a so-called optical axis-free film, the Rth (λ) is calculated in the following manner.

The Re (λ) is measured in 11 points by forming an in-plane slow axis (judged by KOBRA 21ADH or WR) as an axis of tilt (rotating axis) and making light having a wavelength of λ nm incident from an inclined direction at a step of every 100 from −50° to 50° against the film normal direction, and the Rth is calculated by KOBRA 21ADH or WR on the basis of a measured retardation value, a hypothesized value of average refractive index and an inputted film thickness value.

In the foregoing measurement, as the hypothesized value of average refractive index, values described in Polymer Handbook (John Wiley & Sons, Inc.) and catalogues of various optical films can be employed. When a value of average refractive index is not known, it can be measured by an ABBE's refractometer. Values of average refractive index of major optical films are enumerated as follows: cellulose acylate (1.48), cycloolefin polymer (1.52), polycarbonate (1.59), polymethyl methacrylate (1.49) and polystyrene (1.59). By inputting such a hypothesized value of average refractive index and a thickness of the film, nx, ny and nz are computed by KOBRA 21ADH or WR. [Nz=(nx−nz)/(nx−ny)] is further calculated from the thus calculated nx, ny and nz.

Re (590) of the cellulose acylate film of the invention is preferably from 20 to 200 nm, and more preferably from 30 to 150 nm. Rth (590) is preferably from 70 to 400 nm, more preferably from 50 to 400 nm, and further preferably 100 to 300 nm.

Also, an Rth (590)/Re (590) ratio is preferably 1 or more and not more than 10, and more preferably 1.5 or more and not more than 8.

In the OCB mode and TN mode, by coating an optically anisotropic layer on the cellulose acylate film having the foregoing retardation value, the resulting film can be used as an optical compensation film.

In the cellulose acylate film of the invention, what the fluctuation in Re is small as far as possible is preferable because unevenness of a liquid crystal display caused due to the cellulose acylate film per se is small.

In the invention, the fluctuation in Re can be evaluated by measuring Re in 25 points in total of every 20 cm in the width direction and every 20 cm in the longitudinal direction of a sample having a size of 1 m (width direction)×1 m (longitudinal direction) and calculating a coefficient of fluctuation in Re from their average value, maximum value and minimum value on the basis of the following numerical expression (2).

(Coefficient of fluctuation in Re)=100×[(Maximum value of Re)−(Minimum value of Re)]/(Average value of Re) Numerical Expression (2)

In the cellulose acylate film of the invention, it is preferable that the coefficient of fluctuation in Re at a wavelength of 590 nm is preferably not more than 20%, more preferably 0.1% or more and not more than 20%, and further preferably 0.1% or more and not more than 10%.

### (Haze of Film)

The haze of the cellulose acylate film of the invention is preferably from 0.01 to 0.8%, and more preferably from 0.05 to 0.7%. When the haze exceeds 0.8%, a reduction in the contrast of the liquid crystal display is remarkable. The lower the haze, the more excellent the optical performance is. However, taking into account the selection of raw materials and the production management, the foregoing range is preferable.

The measurement of the haze was carried out on a cellulose acylate film sample of the invention having a size of 40 mm×80 mm at 25° C. and 60% RH by using a haze meter (HGM-2DP, manufactured by Suga Test Instruments Co., Ltd.) in conformity with JIS K-7136.

### [Saponification Treatment]

By subjecting the cellulose acylate film of the invention to an alkaline saponification treatment to impart adhesion to polyvinyl alcohol, the cellulose acylate film of the invention can be used as a polarizing plate protective film.

It is preferable that the alkaline saponification treatment of the cellulose acylate film is carried out through a cycle of dipping the film surface with an alkaline solution, neutralizing with an acidic solution, washing with water and drying. Examples of the alkaline solution include a potassium hydroxide aqueous solution and a sodium hydroxide aqueous solution. The normality of a hydroxide ion is preferably in the range of from 0.1 to 5.0 N, and more preferably in the range of from 0.5 to 4.0 N. The temperature of the alkaline solution is preferably in the range of from room temperature to 90° C., and more preferably from 40 to 70° C.

### <Polarizing Plate>

The polarizing plate is composed of a polarizer and two sheets of transparent protective membranes (transparent protective films) disposed on both sides thereof. As one of the protective membranes, the cellulose acylate film of the invention can be used. As the other protective membrane, a usual cellulose acetate film may be used. Examples of the polarizer include an iodine based polarizer, a dye based polarizer using a dichroic dye and a polyene based polarizer. The iodine based polarizer and the dye based polarizer are in general produced by using a polyvinyl alcohol based film. In the case where the cellulose acylate film of the invention is used as a polarizing plate protective membrane, the polarizer is not particularly limited with respect to the preparation method and can be prepared by a general method. There is a method in which the resulting cellulose acylate film is subjected to an alkaline treatment is stuck on both surfaces of a polarizer prepared by dipping and stretching a polyvinyl alcohol film in an iodine solution by using a completely saponified polyvinyl alcohol aqueous solution. Easy-adhesion processing described in JP-A-6-94915 and JP-A-6-118232 may be applied in place of the alkaline treatment. Examples of the adhesive which is used for sticking the protective membrane treatment surface and the polarizer include polyvinyl alcohol based adhesive such as polyvinyl alcohol and polyvinyl butyral; and vinyl based latexes such as butyl acrylate. The polarizer is configured of a polarizer and protective membranes for passivating the both surfaces of the polarizer and further configured such that a protective film is stuck on one surface of the polarizing plate, with a separate film being stuck on the opposite surface. The protective film and the separate film are used for the purpose of protecting the polarizing plate at the shipment of the polarizing plate, the product inspection and so on. In that case, the protective film is stuck for the purpose of protecting the surface of the polarizing plate and is used on an opposite surface side to the surface onto which the polarizing plate is stuck to a liquid crystal plate. Also, the separate film is used for the purpose of covering the adhesive layer to be stuck to a liquid crystal plate and is used on a side of the surface onto which the polarizing plate is stuck to a liquid crystal plate.

In sticking the cellulose acylate film of the invention to the polarizer, it is preferable that sticking is achieved such that a transmission axis of the polarizer and a slow axis of the cellulose acylate film of the invention are coincident with each other. As a result of evaluation of a polarizing plate prepared under a polarizing plate cross Nicol, in the case where the orthogonal accuracy of the slow axis of the cellulose acylate film of the invention to the absorption axis (axis orthogonal to the transmission axis) of the polarizer exceeds 1°, a polarizing plate constructed under cross Nicols suffers from lowering in polarization degree performance and, in its turn, light leaks. By combining such a polarizing plate with a liquid crystal cell, it is impossible to attain a sufficient black level or contrast. Accordingly, it is preferable that the deviation in angle between the direction of the main refractive index nx of the cellulose acylate film of the invention and the direction of the transmission axis of the polarizing plate is not more than 1°, and more preferably not more than 0.5°.

Single-plate transmittance TT, parallel transmittance PT and crossed transmittance CT of the polarizing plate was measured by using UV3100PC (manufactured by Shimadzu Corporation). The measurement was carried out in the range of from 380 nm to 780 nm, and an average value obtained by measurement of 10 times was employed for all of the single-plate transmittance, parallel transmittance and crossed transmittance. A durability test of the polarizing plate was carried out in two kinds of forms including (1) only a polarizing plate and (2) a polarizing plate stuck on a glass via an adhesive in the following manner. For the measurement of only a polarizing plate, two polarizers were combined and crossed so as to interpose an optical compensation membrane therebetween, and two of the same material were prepared and provided for the measurement. For the measurement of a polarizing plate stuck on a glass, two samples (about 5 cm×5 cm) obtained by sticking a polarizing plate on a glass such that an optical compensation membrane is faced at the glass side are prepared. For the measurement of the single-plate transmittance, the film side of the sample is set towards a light source, and the measurement is carried out. The two samples are respectively measured, and an average value thereof is employed as the single-plate transmittance. With respect to the polarization performance, the single-plate transmittance TT, parallel transmittance PT and crossed transmittance CT are preferably in the ranges of (40.0≦TT≦45.0), (30.0≦PT≦40.0) and (CT≦2.0), and more preferably in the ranges of (41.0≦TT≦44.5), (34≦PT≦39.0) and (CT≦1.3) (all units being %). Also, in the durability test of the polarizing plate, it is preferable that a change amount thereof is small.

Also, in the polarizing plate of the invention, when allowed to stand at 60° C. and 95% RH for 500 hours, a change amount of the crossed single-plate transmittance ΔCT (%) and a change amount of the polarization degree ΔP are satisfied with at least one of the following expressions (j) and (k).

−6.0≦ΔCT≦6.0 (j)

−10.0≦ΔP≦0.0 (k)

Here, the change amount is a value obtained by subtracting a measured value before the test from a measured value after the test.

By meeting this requirement, the stability of the polarizing plate during the use or during the storage is ensured.

In the polarizing plate of the invention, it is preferable that an optically anisotropic layer is provided on the protective membrane.

A material of the optically anisotropic layer is not limited, and examples thereof include a liquid crystalline compound, a non-liquid crystalline compound, an inorganic compound and an organic/inorganic composite compound. As the liquid crystalline compound, compounds obtained by orienting a polymerizable group-containing low molecular compound and then immobilizing the orientation by polymerization by light or heat and compounds obtained by heating a liquid crystalline high molecular compound, orienting and then cooling, thereby immobilizing the orientation in a vitrifed state can be used. AS the liquid crystalline compound, compounds having a disc-like structure, compounds having a rod-like structure and compounds having a structure showing optical biaxial properties can be used. As the non-liquid crystalline compound, high molecular compounds having an aromatic ring, such as polyimides and polyesters, can be used.

As a method for forming the optically anisotropic layer, various methods such as coating, vapor deposition and sputtering can be employed.

In the case where the optically anisotropic layer is provided on the protective membrane of the polarizing plate, an adhesive layer is provided outwards the optically anisotropic layer relative to the polarizer side.

As the film (substrate) of the invention and optical films using the same other than the foregoing polarizing plate, for example, the following functional optical films can be configured.

### [Layer Configuration of Functional Optical Film]

The functional optical film can be prepared by providing a single layer or plural layers of a functional layer on a transparent substrate (also called “support”) as the need arises.

As one preferred embodiment, an antireflection film stacked on a substrate so as to reduce a reflectance by optical interference while taking into consideration a refractive index, a thickness, the number of layers, the order of layers and the like can be exemplified. In the antireflection film, the simplest configuration is a configuration in which only a low refractive index layer is provided on a substrate. For the purpose of further reducing the reflectance, it is preferable that the antireflection layer is configured of a combination of a high refractive index layer having a higher refractive index than the substrate and a low refractive index layer having a lower refractive index than the substrate. Examples of this configuration include a configuration of two layers of high refractive index layer/low refractive index layer from the substrate side; and a configuration of three layers having a different refractive index in which middle refractive index layer (a layer having a higher refractive index than a substrate or a hard coat layer and having a lower refractive index than a high refractive index layer)/high refractive index layer/low refractive index layer are stacked in this order from the substrate side. A configuration in which more antireflection layers are stacked is also proposed. Of these, from the standpoints of durability, optical characteristic, costs, productivity and the like, it is preferable that middle refractive index layer/high refractive index layer/low refractive index layer are coated in this order on a substrate having a hard coat layer. For example, configurations described in JP-A-8-122504, JP-A-8-110401, JP-A-10-300902, JP-A-2002-243906 and JP-A-2000-111706 are exemplified.

Also, other function may be imparted to each layer. For example, an antifouling low refractive index layer and an antistatic high refractive index layer (those described in, for example, JP-A-10-206603 and JP-A2002-243906) are exemplified.

Examples of the preferred layer configuration of the foregoing antireflection film will be given below. So far as the reflectance by optical interference can be reduced, it should not be construed that the antireflection film is limited only to these layer configurations. In the following configurations, the substrate film refers to a support which is configured by a film.

Substrate film/low refractive index layer

Substrate film/antistatic layer/low refractive index layer

Substrate film/antiglare layer/low refractive index layer

Substrate film/antiglare layer/antistatic layer/low refractive index layer

Substrate film/hard coat layer/antiglare layer/low refractive index layer

Substrate film/hard coat layer/antiglare layer/anti-static layer/low refractive index layer

Substrate film/hard coat layer/antistatic layer/antiglare layer/low refractive index layer

Substrate film/hard coat layer/high refractive index layer/low refractive index layer

Substrate film/hard coat layer/antistatic layer/high refractive index layer/low refractive index layer

Substrate film/hard coat layer/middle refractive index layer/high refractive index layer/low refractive index layer

Substrate film/antiglare layer/high refractive index layer/low refractive index layer

Substrate film/antiglare layer/middle refractive index layer/high refractive index layer/low refractive index layer

Substrate film/antistatic layer/hard coat layer/middle refractive index layer/high refractive index layer/low refractive index layer

Antistatic layer/substrate film/hard coat layer/middle refractive index layer/high refractive index layer/low refractive index layer

Substrate film/antistatic layer/antiglare layer/middle refractive index layer/high refractive index layer/low refractive index layer

Antistatic layer/substrate film/antiglare layer/middle refractive index layer/high refractive index layer/low refractive index layer

Antistatic layer/substrate film/antiglare layer/high refractive index layer/low refractive index layer/high refractive index layer/low refractive index layer

Also, as another embodiment, a functional optical film in which necessary layers are provided for the purpose of providing hard coat properties, moisture-proof properties, gas barrier properties, antiglare properties, antifouling properties and the like while not positively applying optical interference is also preferable.

Examples of the preferred layer configuration of the film of the foregoing embodiment will be given below. In the following configurations, the substrate film refers to a support which is configured by a film.

Substrate film/hard coat layer

Substrate film/hard coat layer/hard coat layer

Substrate film/antiglare layer

Substrate film/antiglare layer/antiglare layer

Substrate film/hard coat layer/antiglare layer

Substrate film/antiglare layer/hard coat layer

Substrate film/antistatic layer

Substrate film/antistatic layer/hard coat layer

Substrate film/moisture-proof layer

Substrate film/gas barrier layer

Substrate film/hard coat layer/antifouling layer

Antistatic layer/substrate film/hard coat layer

Antistatic layer/substrate film/antiglare layer

Antiglare layer/substrate film/antistatic layer

These layers can be formed by a method such as vapor deposition, atmospheric-pressure plasma and coating. From the viewpoint of productivity, it is preferable that these layers are formed by coating.

Each of the configuration layers is hereunder described.

### (1) Hard Coat Layer:

In the film of the invention, for the purpose of imparting a physical strength of the film, a hard coat layer can be favorably provided on one surface thereof. The hard coat layer may be configured of a stack of two or more layers.

In the invention, from the standpoint of optical design for obtaining an antireflection film, the refractive index of the hard coat layer is preferably in the range of from 1.48 to 2.00, more preferably from 1.52 to 1.90, and further preferably from 1.55 to 1.80. In the embodiment wherein at least one low refractive index layer is provided on the hard coat layer, which is a preferred embodiment of the invention, when the refractive index is too small as compared with this range, the antireflection properties are lowered, whereas when it is too large, the color taste of reflected light tends to become strong.

From the viewpoint of imparting sufficient durability and impact resistance to the film, the thickness of the hard coat layer is usually from about 0.5 μm to 50 μm, preferably from 1 μm to 20 μm, more preferably from 2 μm to 10 μm, and most preferably from 3 μm to 7 μm.

Also, the hardness of the hard coat layer is preferably H or more, more preferably 2H or more, and most preferably 3H or more in a pencil hardness test.

Furthermore, it is preferable that the wear amount of a specimen before and after the test by a taber test according to JIS K5400 is small as far as possible.

It is preferable that the hard coat layer is formed by a crosslinking reaction or polymerization reaction of an ionizing radiation hardenable compound. For example, the hard coat layer can be formed by coating a coating composition containing an ionizing radiation hardenable polyfunctional monomer or polyfunctional oligomer on a transparent support and subjecting the polyfunctional monomer or polyfunctional oligomer to a crosslinking reaction or polymerization reaction.

As the functional group of the ionizing radiation hardenable polyfunctional monomer or polyfunctional oligomer, photo, electron beam or ionizing radiation polymerizable functional groups are preferable. Above all, photopolymerizable functional groups are preferable.

Examples of the photopolymerizable functional group include unsaturated polymerizable functional groups such as a (meth)acryloyl group, a vinyl group, a styryl group and an allyl group, with a (meth)acryloyl group being preferable.

A crosslinking functional group may be introduced into the binder in place of, or in addition to, the foregoing polymerizable unsaturated group-containing monomer. Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Vinylsulfonic acid, acid anhydrides, cyano acrylate derivatives, melamine, etherified methylol, esters and urethanes, and metal alkoxides such as tetramethoxysilane can also be used as the monomer having a crosslinking structure. A functional group exhibiting crosslinking properties as a result of decomposition reaction, such as a block isocyanate group, may be used. That is, in the invention, the crosslinking functional group may be a crosslinking functional group which does not immediately exhibit reactivity but exhibits reactivity as a result of decomposition. After coating, the binder polymer containing such a crosslinking functional group is able to form a crosslinking structure by heating.

For the purpose of imparting internal scattering properties, the hard coat layer may contain a mat particle having an average particle size of from 1.0 to 15.0 μm, and preferably from 1.5 to 10.0 μm, for example, a particle of an inorganic compound or a resin particle.

For the purpose of controlling the refractive index of the hard coat layer, a high refractive index monomer or an inorganic particle or the both can be added in a binder of the hard coat layer. The inorganic particle has an effect for suppressing hardening and shrinkage due to the crosslinking reaction in addition to the effect for controlling the refractive index. In the invention, it is called a binder including a polymer as formed by polymerization of the foregoing polyfunctional monomer and/or high refractive index monomer, etc. and an inorganic particle as dispersed therein after the formation of the hard coat layer.

The haze of the hard coat layer varies with the function which is imparted to the functional optical film.

In the case of keeping the sharpness of an image, suppressing a refractive index of the surface and not imparting an optical scattering function on the inside and surface of the hard coat layer, it is preferable that a haze value is low as far as possible. Concretely, the haze value is preferably not more than 10%, more preferably not more than 5%, and most preferably not more than 2%.

On the other hand, in the case of imparting an antiglare function by surface scattering of the hard coat layer, a surface haze is preferably from 5% to 15%, and more preferably from 5% to 10%.

Also, in the case of making it hard to view a pattern, color unevenness, luminance unevenness and glare of a liquid panel due to internal scattering of the hard coat layer or imparting a function to enlarge a viewing angle by scattering, an internal haze value (a value obtained by subtracting a surface haze value from the total haze value) is preferably from 10% to 90%, more preferably from 15% to 80%, and most preferably 20% to 70%.

In the film of the invention, it is possible to freely set up the surface haze and internal haze depending upon the purpose.

Also, with respect to the surface irregular shape of the hard coat layer, for the purpose of keeping the sharpness of an image, in order to obtain a clear surface, it is preferable that among characteristics exhibiting the surface roughness, for example, a center line average roughness (Ra) is not more than 0.08 μm. Ra is more preferably not more than 0.07 μm, and more preferably not more than 0.06 μm. In the film of the invention, the surface irregularities of the hard coat layer are dominant for the surface irregularities of the film. By adjusting the center line average roughness of the hard coat layer, it is possible to make the center line average roughness of the antireflection film fall within the foregoing range.

In addition to the adjustment of the irregular shape of the surface, for the purpose of keeping the sharpness of an image, it is preferred to adjust the transmitted image sharpness. In order to obtain a clear antireflection film, the transmitted image sharpness is preferably 60% or more. In general, the transmitted image sharpness is an index to show a blurring degree of an image reflected through the film, and it is meant that when this value is large, the image seen through the film is sharp and good. The transmitted image sharpness is preferably 70% or more, and more preferably 80% or more.

### [Photoinitiator]

Examples of the photo radical polymerization initiator include acetophenones, benzoins, benzophenones, phosphine oxides, ketals, anthraquinones, thioxanthones, azo compounds, peroxides (for example, ones described in JP-A-2001-139663), 2,3-dialkyldione compounds, disulfide compounds, fluoroamine compounds, aromatic sulfoniums, lophine dimers, onium salts, borate salts, active esters, active halogens, inorganic complexes and coumarins.

Such an initiator may be used singly or in admixture.

A variety of examples are described in Saishin UV Koka Gijutsu (Latest UV Curing Technologies), published by Technical Information Institute Co., Ltd., page 159 (1991) and Kiyoshi Kato, Shigaisen Koka Shisutemu (Ultraviolet Ray Curing Systems), published by Sogo Gijutsu Center, pages 65 to 148 (1988) are useful in the invention.

With respect to commercially available photo radical polymerization initiators, KAYACURE Series as manufactured by Nippon Kayaku Co., Ltd. (for example, DETX-S, BP-100, BDMK, CTX, BMS, 2-FAQ, ABQ, CPTX, EPD, ITX, QTX, BTC and MCA), IRGACURE Series as manufactured by Ciba Specialty Chemicals (for example, 651, 184, 500, 819, 907, 369, 1173, 1870, 2959, 4265 and 4263), ESACURE Series as manufactured by Sartmer Company Inc. (for example, KIP100F, KB1, EB3, BP, X33, KT046, KT37, KIP150 and TZT), and combinations thereof are enumerated as preferred examples.

The photopolymerization initiator is preferably used in an amount in the range of from 0.1 to 15 parts by mass, and more preferably from 1 to 10 parts by mass based on 100 parts by mass of the polyfunctional monomer.

### [Surface Property Improving Agent]

In order to improve defective surface properties (for example, coating unevenness, drying unevenness and point defect), it is preferred to add at least a fluorine based surface property improving agent or a silicone based surface property improving agent in a coating solution which is used for preparing any one of layers on the support.

The surface property improving agent preferably changes a surface tension of the coating solution by 1 mN/m or more. Here, what the surface tension of the coating solution is changed by 1 mN/m or more means that the surface tension of the coating solution after adding the surface property improving agent is changed by 1 mN/m or more at the coating/drying inclusive of a concentration step as compared with a surface tension of a coating solution in which the surface property improving agent is not added. The surface property improving agent is preferably a surface property improving agent having an effect for decreasing the surface tension of the coating solution by 1 mN/m or more, a more preferably a surface property improving agent having an effect for decreasing the surface tension of the coating solution by 2 mN/m or more, and especially preferably a surface property improving agent having an effect for decreasing the surface tension of the coating solution by 3 mN/m or more.

As a preferred example of the fluorine based surface property improving agent, a compound containing a fluoro aliphatic group is exemplified. Preferred examples of the compound include compounds described in JP-A-2005-115359, JP-A-2005-221963 and JP-A-2005-234476.

### (2) Antiglare Layer:

An antiglare layer is formed for the purpose of imparting antiglare properties due to surface scattering, and preferably hard coat properties for enhancing the scar resistance of the film to the film.

As a method of forming the antiglare layer, there are known a method of forming an antiglare layer by laminating a mat-like shaping film having fine irregularities on the surface thereof as described in JP-A-6-16851; a method of forming an antiglare layer by hardening and shrinking an ionizing radiation hardenable resin due to a difference of an ionizing radiation dose as described in JP-A-2000-206317; a method of forming an antiglare layer by solidifying a translucent fine particle and a translucent resin while gelling by utilizing a reduction of the weight ratio of a good solvent against the translucent resin upon drying, thereby forming irregularities on the film surface as described in JP-A-2000-338310; a method of forming an antiglare layer by imparting surface irregularities by a pressure from the outside as described in JP-A-2000-275404; and a method of forming surface irregularities by utilizing the occurrence of phase separation during a step of vaporization of a solvent from a mixed solution of plural polymers as described in JP-A-2005-195819. These known methods can be utilized.

In the antiglare layer which can be used in the invention, it is preferable that a binder capable of imparting hard coat properties, a translucent particle for imparting antiglare properties and a solvent are contained as essential components and that surface irregularities are formed by projections of the translucent particle itself or projections formed by an agglomerate of plural particles.

The antiglare layer formed by dispersing a mat particle is composed of a binder and a translucent particle as dispersed in the binder. It is preferable that the antiglare layer having antiglare properties has both antiglare properties and hard coat properties.

Specific examples of the mat particle which is favorable include particles of an inorganic compound such as a silica particle and a TiO₂ particle; and resin particles such as an acrylic resin particle, a crosslinked acrylic resin particle, a polystyrene particle, a crosslinked styrene resin particle, a melamine resin particle and a benzoguanamine resin particle. Of these, a crosslinked styrene resin particle, a crosslinked acrylic resin particle, and a silica particle are preferable. The shape of the mat particle which can be employed may be either spherical or amorphous.

Also, two or more kinds of mat particles having a different particle size may be used jointly. It is possible to impart antiglare properties by a mat particle having a larger particle size and to impart a separate optical characteristic by a mat particle having a smaller particle size. For example, in the case of sticking an antireflection film onto a display with high definition of 133 ppi or more, there may be the case where an inconvenience on display image grade called as “glare”. The “glare” is derived from the matter that pixels are enlarged or contracted due to irregularities present on the film surface, thereby loosing the uniformity of luminance. It is possible to largely improve the glare at a smaller particle size than that of the mat particle for imparting antiglare properties by jointly using a mat particle having a different refractive index from the binder.

The foregoing mat particle is contained such that the amount of the mat particle in the formed antiglare hard coat layer is preferably from 10 to 1,000 mg/m², and more preferably from 100 to 700 mg/m².

The thickness of the antiglare layer is preferably from 1 to 20 μm, and more preferably from 2 to 10 μm. When the thickness of the antiglare layer falls within the foregoing range, the hard coat properties, curl and brittleness can be satisfied.

On the other hand, the center line average roughness (Ra) of the antiglare layer is preferably in the range of from 0.09 to 0.40 μm. When the center line average roughness (Ra) of the antiglare layer exceeds 0.40 μm, glare or a problem such as whitening of the surface caused when external light is reflected is generated. Also, a value of the transmitted image sharpness is preferably from 5 to 60%.

The strength of the antiglare layer is preferably H or more, more preferably 2H or more, and most preferably 3H or more in a pencil hardness test.

### (3) High Refractive Index Layer and Middle Refractive Index Layer:

In the film of the invention, the antireflection properties can be enhanced by providing a high refractive index layer and a middle refractive index layer and utilizing optical interference along with a low refractive index layer as described later.

In this specification, the high refractive index layer and the middle refractive index layer will be sometimes named generically as a high refractive index layer. Incidentally, in the invention, the terms “high”, “middle” and “low” of the high refractive index layer, middle refractive index layer and low refractive index layer express a relative large and small relation mutually among the layers. Furthermore, so far as the relationship with the transparent support is concerned, it is preferable that the refractive index is satisfied with the relationships of [(transparent support)>(low refractive index layer)] and [(high refractive index layer)>(transparent support)].

Furthermore, in this specification, the high refractive index layer, the middle refractive index layer and the low refractive index layer will be sometimes named generically as an antireflection layer.

For the purpose of constructing a low refractive index layer on a high refractive index layer to prepare an anti-reflection film, the high refractive index layer preferably has a refractive index of from 1.55 to 2.40, more preferably from 1.60 to 2.20, further preferably from 1.65 to 2.10, and most preferably from 1.80 to 2.00.

In the case where a middle refractive index layer, a high refractive index layer and a low refractive index layer are coated and provided in this order on a support to prepare an antireflection film, the high refractive index layer preferably has a refractive index of from 1.65 to 2.40, and more preferably from 1.70 to 2.20. The refractive index of the middle refractive index layer is adjusted so as to have a value between a refractive index of the low refractive index layer and a refractive index of the high refractive index layer. The refractive index of the middle refractive index layer is preferably from 1.55 to 1.80.

Specific examples of the fine inorganic filler which is used in the high refractive index layer and the middle refractive index layer include TiO₂, ZrO₂, Al₂O₃, In₂O₃, ZnO, SnO₂, Sb₂O₃, ITO and SiO₂. Of these, TiO₂ and ZrO₂ are especially preferable in view of realizing a high refractive index. It is also preferable that a surface of the subject inorganic filler is subjected to a silane coupling treatment or a titanium coupling treatment, and a surface treating agent containing a functional group capable of reacting with a species of the binder on the filler surface is preferably used.

The content of the inorganic particle in the high refractive index layer is preferably from 10 to 90% by mass, more preferably from 15 to 80% by mass, and especially preferably from 15 to 75% by mass relative to the mass of the high refractive index layer. Two or more kinds of the inorganic particle may be used jointly in the high refractive index layer.

In the case where the low refractive index layer is present on the high refractive index layer, it is preferable that the refractive index of the high refractive index layer is higher than that of the transparent support.

In the high refractive index layer, a binder obtained by a crosslinking or polymerization reaction, such as ionizing radiation hardenable compounds containing an aromatic ring, ionizing radiation hardenable compounds containing a halogen element other than fluorine (for example, Br, I and Cl) and ionizing radiation hardenable compounds containing an atom such as S, N and P, can be preferably used.

The thickness of the high refractive index layer can be adequately designed depending upon the utility. In the case where the high refractive index layer is used as an optical interference layer as described layer, the thickness of the high refractive index layer is preferably from 30 to 200 nm, more preferably from 50 to 170 nm, and especially preferably from 60 to 150 nm.

In the case where a particle capable of imparting an antiglare function is not contained, it is preferable that the haze of the high refractive index layer is low as far as possible. The haze of the high refractive index layer is preferably not higher than 5%, more preferably not more than 3%, and especially preferably not more than 1%. It is preferable that the high refractive index layer is constructed on the foregoing transparent support directly or via other layer.

### (4) Low Refractive Index Layer:

In order to reduce the reflectance of the film of the invention, it is preferred to use a low refractive index layer.

The refractive index of the low refractive index layer is preferably from 1.20 to 1.46, more preferably from 1.25 to 1.46, and especially preferably from 1.30 to 1.48.

The thickness of the low refractive index layer is preferably from 50 to 200 nm, and more preferably from 70 to 100 nm. The haze of the low refractive index layer is preferably not more than 3%, more preferably not more than 2%, and most preferably not more than 1%. A concrete strength of the low refractive index layer is preferably H or more, more preferably 2H or more, and most preferably 3H or more according to a pencil hardness test with a load of 500 g.

Also, for the purpose of improving the antifouling performance of an optical film, a contact angle of the surface against water is preferably 90 degrees or more, more preferably 95 degrees or more, and especially preferably 100 degrees or more.

As preferred embodiments of the hardening material composition, there are exemplified (I) a composition containing a fluorine-containing polymer having a crosslinkable or polymerizable functional group; (II) a composition containing, as a main component, a hydrolysis condensate of a fluorine-containing organosilane material; and (III) a composition containing a monomer having two or more ethylenically unsaturated groups and an inorganic fine particle having a hollow structure.

### (I) Fluorine-Containing Compound Having a Crosslinking or Polymerizable Functional Group:

Examples of the fluorine-containing compound having a crosslinking or polymerizable functional group include copolymers of a fluorine-containing monomer and a crosslinking or polymerizable functional group. Examples of the fluorine-containing monomer include fluoroolefins (for example, fluoroethylene, vinylidene fluoride, tetrafluoroethylene, hexafluoroethylene, hexafluoropropylene and perfluoro-2,2-dimethyl-1,3-dioxol), partially or completely fluorinated alkyl ester derivatives of (meth)acrylic acid (for example, VISCOAT 6FM (manufactured by Osaka Organic Chemical Industry Ltd.) and M-2020 (manufactured by Daikin Industries, Ltd.)), and completely or partially fluorinated vinyl ethers.

With respect to the monomer for imparting a crosslinking group, as one embodiment, a (meth)acrylate monomer having a crosslinking functional group in advance in a molecule thereof, such as glycidyl methacrylate, can be exemplified. As another embodiment, there is a method of introducing a crosslinking or polymerizable functional monomer by synthesizing a fluorine-containing copolymer by using a monomer having a functional group such as a hydroxyl group and then modifying the substituent. Examples of such a monomer include (meth)acrylate monomers containing a carboxyl group, a hydroxyl group, an amino group, a sulfo group, etc. (for example, (meth)acrylic acid, methylol (meth)acrylate, hydroxyalkyl (meth)acrylates and allyl acrylate). The latter embodiment is disclosed in JP-A-10-25388 and JP-A-10-147739.

From the viewpoints of dissolution properties, dispersibility, coating properties, antifouling properties, antistatic properties and so on, the foregoing fluorine-containing copolymer can properly contain a copolymerizable component. In particular, for the purpose of imparting antifouling properties and slipperiness, it is preferable that a silicone is introduced, and it is also possible to introduce a silicone into a principal chain.

As a method of introducing a polysiloxane partial structure into the principal chain, there is exemplified a method of using a polymer type initiator such as an azo group-containing polysiloxane amide (for example, commercially available VPS-0501 and VPS-1001 (trade names, manufactured by Wako Pure Chemicals Industries, Ltd.)) as described in JP-A-6-93100. Also, examples of a method of introducing a polysiloxane partial structure into a side chain include a method of introducing a polysiloxane having a reactive group at one terminal thereof [for example, SILAPLANE Series (manufactured by Chisso Corporation)] by a polymerization reaction as described in, for example, J. Appl. Polym. Sci., 78, 1955 (2000) and JP-A-56-28219; and a method of polymerizing a polysiloxane-containing silicon macromer.

The foregoing polymer may be properly used together with a hardening agent containing a polymerizable unsaturated group as described in JP-A-2000-17028. It is also preferable that the polymer is used together with a fluorine-containing polyfunctional polymerizable unsaturated group-containing compound as described in JP-A-2002-145952. Examples of the polyfunctional polymerizable unsaturated group-containing compound include the foregoing monomers having two or more ethylenically unsaturated groups. A hydrolysis condensate of an organosilane described in JP-A-2004-170901 is also preferable, and a hydrolysis condensate of an organosilane containing a (meth)acryloyl group is especially preferable.

Such a compound is preferable because when a compound having a polymerizable unsaturated group is used in the polymer main body, its joint use effect for improving the scar resistance is especially high.

In the case where the polymer itself does not have sufficient hardening properties singly, by blending a crosslinking compound, necessary hardening properties can be imparted. For example, in the case where the polymer main body contains a hydroxyl group, it is preferable that various amino compounds are used as a hardening agent. The amino compound which is used as the crosslinking compound is, for example, a compound having two or more in total of either one or both of a hydroxyalkylamino group and an alkoxyalkylamino group. Specific examples thereof include melamine based compounds, urea based compounds, benzoguanamine based compounds and glycol uryl based compounds. For hardening such a compound, it is preferred to use an organic acid or a salt thereof.

Specific examples of such a fluorine-containing polymer are described in JP-A-2003-222702 and JP-A-2003-183322.

### (II) Hydrolysis Condensate of Fluorine-Containing Organosilane Material:

A composition containing, as a main component, a hydrolysis condensate of a fluorine-containing organosilane compound is also preferable because it is low in refractive index and high in hardness of a coating surface. A condensate of a compound containing a hydrolyzable silanol at one terminal or both terminals relative to a fluorinated alkyl group and a tetraalkoxysilane is preferable. Specific compositions are described in JP-A-2002-265866 and JP-A-2002-317152.

### (III) Composition Containing a Monomer Having Two or More Ethylenically Unsaturated Groups and an Inorganic Fine Particle Having a Hollow Structure:

As still another preferred embodiment, a low refractive index layer composed of a low refractive index particle and a binder is exemplified. The low refractive index particle may be organic or inorganic, and particles having pores in the inside thereof are preferable. As specific examples of the hollow particle, silica based particles described in JP-A-2002-79616 are described. The refractive index of the particle is preferably from 1.15 to 1.40, and more preferably from 1.20 to 1.30. As the binder, the foregoing monomers having two or more ethylenically unsaturated groups can be exemplified.

It is preferable that the polymerization initiator as described above in the section of the hard coat layer is added in the low refractive index layer. In the case of containing a radical polymerizable compound, the polymerization initiator can be used in an amount of from 1 to 10 parts by mass, and more preferably from 1 to 5 parts by mass relative to the subject compound.

An inorganic particle can be used jointly in the low refractive index layer of the invention. In order to impart scar resistance, a fine particle containing having a particle having from 15% to 150%, preferably 30% to 100%, and more preferably from 45% to 60% of the thickness of the low refractive index layer can be used.

For the purpose of imparting characteristics such as antifouling properties, water resistance, chemical resistance and slipperiness, a known polysiloxane based or fluorine based antifouling agent, a slipping agent and the like can be properly added in the low refractive index layer of the invention.

### (5) Antistatic Layer:

In the invention, it is preferred from the standpoint of destaticization on the film surface to provide an antistatic layer. Examples of a method of forming an antistatic layer include conventionally known methods such as a method of coating a conductive coating solution containing a conductive fine particle and a reactive hardenable resin and a method of forming a conductive thin film by vapor deposition or sputtering of a metal or metal oxide capable of forming a transparent film or the like. The conductive layer can be formed on the support directly or via a primer layer capable of strengthening adhesion to the support. Furthermore, the antistatic layer can be used as a part of the antireflection film. In that case, in the case where the antistatic layer is used in a layer close to the outermost layer, even when the film is thin, it is possible to sufficiently obtain antistatic properties.

The antistatic layer preferably has a thickness of from 0.01 to 10 μm, more preferably from 0.03 to 7 μm, and further preferably from 0.05 to 5 μm. The antistatic layer preferably has a surface resistivity of from 10⁵ to 10¹² Ω/sq, more preferably from 10⁵ to 10⁹ Ω/sq, and most preferably from 10⁵ to 10⁸ Ω/sq. The surface resistivity of the antistatic layer can be measured by a four probe method.

It is preferable that the antistatic layer is substantially transparent. Concretely, the antistatic layer preferably a haze of not more than 10%, more preferably not more than 5%, further preferably not more than 3%, and most preferably not more than 1%. The antistatic layer preferably has a transmittance against light having a wavelength of 550 nm of 50% or more, more preferably 60% or more, further preferably 65% or more, and most preferably 70% or more.

The antistatic layer of the invention is excellent in strength. Concretely, the antistatic layer preferably has a strength of H or more, more preferably 2H or more, further preferably 3H or more, and most preferably 4H or more in terms of a pencil hardness with a load of 1 kg.

### [Coating Solvent]

Of the foregoing respective configuration layers, in a layer to be coated adjacent to the substrate film, it is preferable that at least one solvent which dissolves the substrate film therein and at least one solvent which does not dissolve the substrate film therein are contained. By taking such an embodiment, it is possible to make it to achieve both prevention of excessive bleeding of the components of the adjacent layer into the substrate film and insurance of adhesion between the adjacent layer and the substrate film. Also, it is more preferable that the at least one solvent which dissolves the substrate film therein has a higher boiling point than the at least one solvent which does not dissolve the substrate film therein. It is further preferable that a temperature difference in boiling point between a solvent having a highest boiling point among the solvents which dissolve the substrate film therein and a solvent having a highest boiling point among the solvents which do not dissolve the substrate film therein is 30° C. or more. This temperature difference in boiling point is most preferably 40° C. or more.

A mass proportion (A/B) of the total sum (A) of the solvents which dissolve the transparent substrate film therein to the total sum (B) of the solvents which do not dissolve the transparent substrate film therein is preferably 5/95 to 50/50, more preferably from 10/90 to 40/60, and further preferably from 15/85 to 30/70.

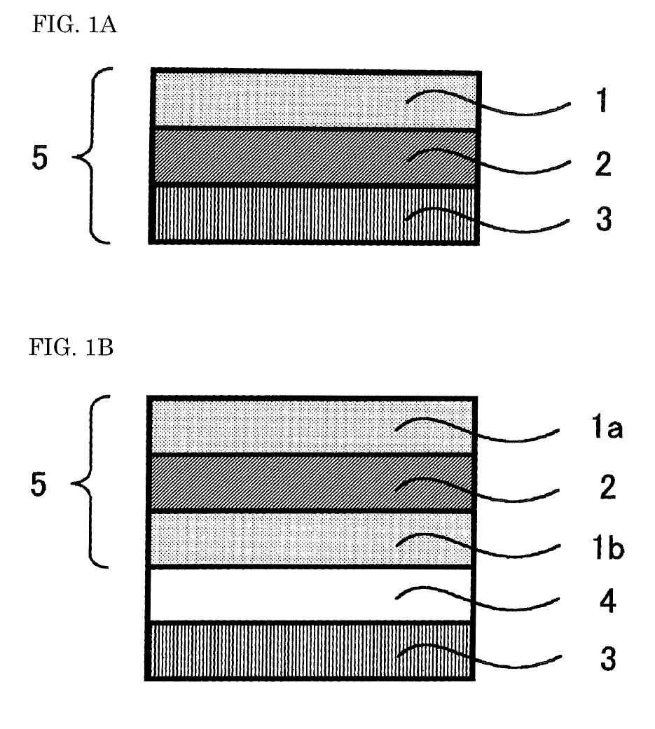

An embodiment of the polarizing plate of the invention is one provided with the foregoing functional optical film. FIGS. 1A and 1B are each a cross-sectional view for explaining one example of a composite configuration of the polarizing plate of the invention and a functional optical film. In FIG. 1A, a polarizing plate 5 of the invention is one in which the cellulose acylate film of the invention is stuck as a protective film 1 on one surface of a polarizer 2 and a functional optical film 3 as described above is stuck on the other surface of the polarizer 2. Also, in FIG. 1B, the polarizer 5 of the invention is one in which the cellulose acylate film of the invention is stuck as protective films 1a and 1b on both surfaces of the polarizer 2 and the foregoing functional optical film 3 is stuck on a surface of the protective film 1b on an opposite side to the polarizer 2 via an adhesive layer 4.

### [Liquid Crystal Display Using Polarizing Plate]

The cellulose acylate film of the invention, the optical compensation sheet composed of this film and the polarizing plate using this film can be used in liquid crystal cells and liquid crystal displays of various display modes.

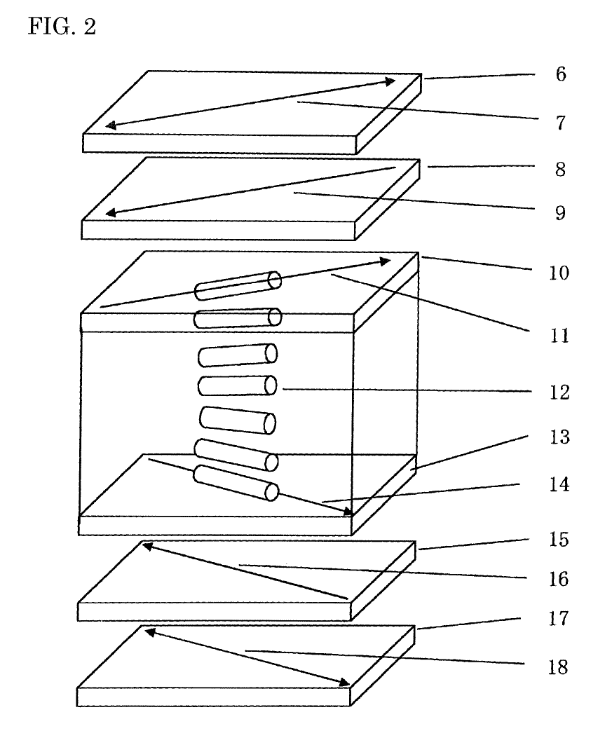

FIG. 2 is a view for explaining one example of a liquid crystal display in which the polarizing plate of the invention is used. In FIG. 2, the liquid crystal display has a structure having a liquid crystal cell containing a liquid crystal molecule 12 between an upper polarizing plate 6 and a lower polarizing plate 17. The liquid crystal cell is provided with a liquid crystal cell upper electrode substrate 10 and a liquid crystal cell lower electrode substrate 13. Also, an upper optically anisotropic layer 8 is provided between the upper polarizing plate 6 and the liquid crystal cell; and a lower optically anisotropic layer 15 is provided between the lower polarizing plate 17 and the liquid crystal cell. An upper polarizing plate absorption axis 7, an upper substrate orientation controlling direction 11 and an upper optically anisotropic layer orientation controlling direction 9 are parallel to each other; and a lower polarizing plate absorption axis 18, a lower substrate orientation controlling direction 14 and a lower optically anisotropic layer orientation controlling direction 16 are orthogonal to the foregoing directions.

As the display mode of the liquid crystal cell, various display modes such as a TN (twisted nematic) mode, an IPS (in-plane switching) mode, an FLC (ferroelectric liquid crystal) mode, an AFLC (anti-ferroelectric liquid crystal) mode, an OCB (optically compensatory bend) mode, an STN (super twisted nematic) mode, a VA (vertically aligned) mode and an HAN (hybrid aligned nematic) mode are proposed.

A liquid crystal cell of an OCB mode is a liquid crystal display using a liquid crystal cell of a bend alignment mode in which a rod-like liquid crystalline molecule is aligned in a substantially reverse direction (in a symmetric manner) in the upper and lower parts of a liquid crystal cell and is disclosed in U.S. Pat. Nos. 4,583,825 and 5,410,422. Since the rod-like liquid crystal molecule is symmetrically aligned in the upper and lower parts of a liquid crystal cell, the liquid crystal cell of a bend alignment mode has a self optical compensating ability. For that reason, this liquid crystal mode is also named as an OCB (optically compensatory bend) liquid crystal mode. A liquid crystal display of a bend alignment mode involves an advantage that the response speed is fast.

In a liquid crystal cell of a VA mode, a rod-like liquid crystalline molecule I substantially vertically aligned at the time of applying no voltage.

The liquid crystal cell of a VA mode includes, in addition to (1) a liquid crystal cell of a VA mode in a narrow sense in which a rod-like liquid crystalline molecule is substantially vertically aligned at the time of applying no voltage, whereas it is substantially horizontally aligned at the time of applying a voltage (as described in JP-A-2-176625); (2) a liquid crystal cell of a multi-domained VA mode (MVA mode) for enlarging a viewing angle (as described in SID 97, Digest of Tech. Papers, 28 (1997), page 845); (3) a liquid crystal cell of a mode (n-ASM mode) in which a rod-like liquid crystalline molecule is substantially vertically aligned at the time of applying no voltage and is subjected to twisted multi-domain alignment at the time of applying a voltage (as described in Sharp Technical Report, No. 80, page 11); and (4) a liquid crystal cell of a SURVIVAL mode (as announced in Monthly Display, May, page 14 (1999)).

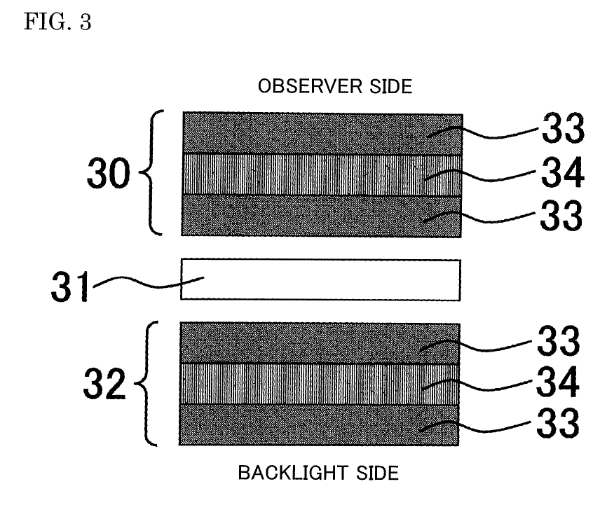

FIG. 3 is a cross-sectional view for explaining one example of a VA mode liquid crystal display in which the polarizing plate of the invention is used. A liquid crystal display of a VA mode is composed of a VA mode liquid crystal cell 31 and two polarizing plates 30 and 32 disposed on the both sides thereof. The VA mode liquid crystal cell 31 supports a liquid crystal between two electrode substrates. The polarizing plates 30 and 32 disposed on an observer side are each in a form that a polarizer 34 is interposed between cellulose acylate films 33. At least one of the two cellulose acylate films disposed on the liquid crystal cell side is the cellulose acylate film of the invention.

In another embodiment of the liquid crystal display of the invention, an optical compensation sheet composed of the cellulose acylate film of the invention is used as a transparent protective membrane to be disposed between a liquid crystal cell and a polarizer. The foregoing optical compensation sheet may be used only for the transparent protective membrane of one polarizing plate (between the liquid crystal cell and the polarizer), or the foregoing optical compensation sheet may be used for the two protective membranes of the both polarizing plates (between the liquid crystal cell and the polarizer). In the case where the foregoing optical compensation sheet is used only for one polarizing plate, it is especially preferable that it is used as a protective membrane on the liquid crystal cell side of the polarizing plate on a backlight side of the liquid crystal cell. In sticking to the liquid crystal cell, it is preferable that the cellulose acylate film of the invention is faced at the VA cell side. The protective membrane may be a usual cellulose acylate film, and it is preferable that such a cellulose acylate film is thinner than the cellulose acylate film of the invention. For example, its thickness is preferably from 40 to 80 μm, and examples of the cellulose acylate film include commercially available products such as KC4UX2M (40 μm in thickness, manufactured by Konica Opto Corp.), KC5UX (60 μm in thickness, manufactured by Konica Opto Corp.) and TD80 (80 μm in thickness, manufactured by Fujifilm Corporation). However, it should not be construed that the invention is limited thereto.

### EXAMPLES

The invention is specifically described below with reference to the following Examples, but it should not be construed that the invention is limited thereto.

### [Preparation of Cellulose Acylate Film]

### Example 1-1

### Preparation of Cellulose Acetate Film (CAF-1)

### [Preparation of Cellulose Acetate Stock Solution (CAL-1)]

The following composition was thrown into a mixing tank and stirred to dissolve the respective components, thereby preparing a cellulose acetate stock solution (CAL-1).

[Composition of cellulose acetate stock solution (CAL-1)]

| | |
|---|---|
| Cellulose acetate (acetylation degree: 2.83): | 100.0 parts by mass |
| Triphenyl phosphate (plasticizer, hereinafter | 7.0 parts by mass |
| referred to as “TPP”): | |
| Biphenyl phosphate (plasticizer, hereinafter | 3.5 parts by mass |
| referred to as “BDP”): | |
| Methylene chloride (first solvent): | 425.0 parts by mass |
| Methanol (second solvent): | 37.0 parts by mass |

### [Preparation of Matting Agent Solution (Ma-1)]

The following composition was thrown into a dispersing machine and stirred to dissolve the respective components, thereby preparing a matting agent solution (Ma-1).

[Composition of matting agent solution (Ma-1)]

| | |
|---|---|
| Silica particle having an average particle | 2.0 parts by mass |
| size of 20 nm (AEROSIL R972, manufactured | |
| by Nippon Aerosil Co., Ltd.): | |
| Methylene chloride (first solvent): | 80.6 parts by mass |
| Methanol (second solvent): | 7.0 parts by mass |
| Cellulose acetate stock solution (CAL-1): | 10.3 parts by mass |

### [Preparation of Retardation Expressing Agent Solution (Re-1)]

The following composition was thrown into a mixing tank and stirred while heating to dissolve the respective components, thereby preparing a retardation expressing agent solution (Re-1).

[Composition of retardation expressing agent solution (Re-1)]

| | |
|---|---|
| Retardation expressing agent A as described below: | 20.0 parts by mass |
| Methylene chloride (first solvent): | 61.7 parts by mass |
| Methanol (second solvent): | 5.4 parts by mass |
| Cellulose acetate stock solution (CAL-1): | 12.8 parts by mass |

Retardation Expression Agent A

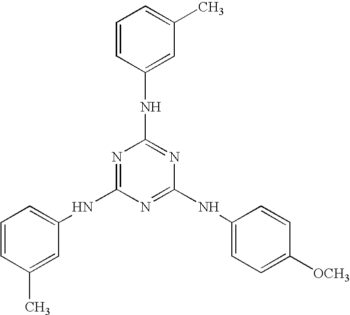

### [Preparation of Cellulose Acetate Film (CAF-1)]

93.7 pars by mass of the cellulose acetate stock solution (CAL-1), 1.3 parts by mass of the matting agent solution (Ma-1) and 5.0 parts by mass of the retardation expressing agent solution (Re-1) were respectively filtered and then mixed, and the mixture was cast by using a band casting machine. A film obtained at the content of the residual solvent of 75% by mass was separated from the band and laterally stretched by 25% at a stretching rate of 35%/min at a circumferential temperature of 130° C. by using a tenter, thereby producing a cellulose acetate film (CAF-1). The content of the residual solvent at the start of stretching was 60% by mass. Details of the composition of each of the cellulose acetate film and dope solvent and the stretching condition are shown in Tables 1 and 2.

### Examples 1-2 to 1-12

### Preparation of Cellulose Acetate Films (CAF-2) to (CAF-12)

Cellulose acetate films (CAF-2) to (CAF-12) were prepared in the same manner as in Example 1-1, except that in the preparation of the cellulose film (CAF-1), the composition of the dope solvent, the kind of cellulose acetate, the kind and addition amount of the additive and the stretching condition were changed as shown in Tables 1 and 2.

### Comparative Examples 1-1 to 1-5

### Preparation of Cellulose Acetate Films (CAF-21) to (CAF-25)

Cellulose acetate films (CAF-21) to (CAF-25) were prepared in the same manner as in Example 1-1, except that in the preparation of the cellulose film (CAF-1), the composition of the dope solvent, the kind of cellulose acetate, the kind and addition amount of the additive and the stretching condition were changed as shown in Tables 1 and 2.

TABLE 1

Cellulose acylate film (composition)

| | | Cellulose acylate | | |
|---|---|---|---|---|
| | | Total acyl substitution | | |
| | No. | degree | Acetylation degree | Propioylation degree |
| Ex. 1-1 | CAF-1 | 2.83 | 2.83 | — |
| Ex. 1-2 | CAF-2 | 2.75 | 2.75 | — |
| Ex. 1-3 | CAF-3 | 2.80 | 2.80 | — |
| Ex. 1-4 | CAF-4 | 2.83 | 2.83 | — |
| Ex. 1-5 | CAF-5 | 2.83 | 2.83 | — |
| Ex. 1-6 | CAF-6 | 2.83 | 2.83 | — |
| Ex. 1-7 | CAF-7 | 2.75 | 2.75 | — |
| Ex. 1-8 | CAF-8 | 2.95 | 2.95 | — |
| Ex. 1-9 | CAF-9 | 2.70 | 1.90 | 0.70 |
| Ex. 1-10 | CAF-10 | 2.83 | 2.83 | — |
| Ex. 1-11 | CAF-11 | 2.83 | 2.83 | — |
| Ex. 1-12 | CAF-12 | 2.83 | 2.83 | — |
| Com. Ex. 1-1 | CAF-21 | 2.83 | 2.83 | — |
| Com. Ex. 1-2 | CAF-22 | 2.83 | 2.83 | — |
| Com. Ex. 1-3 | CAF-23 | 2.83 | 2.83 | — |
| Com. Ex. 1-4 | CAF-24 | 2.83 | 2.83 | — |
| Com. Ex. 1-5 | CAF-25 | 2.83 | 2.83 | — |

| | Cellulose acylate film (composition) | | | | | |
|---|---|---|---|---|---|---|
| | | Composition of dope solvent | | | | |
| | | Methylene chloride | Methanol | Ethanol | 1-Butanol | Σ (Ri-Ci) |
| | No. | (% by mass) | (% by mass) | (% by mass) | (% by mass) | (% by mass) |
| Ex. 1-1 | CAF-1 | 92 | 8 | 0 | 0 | 8 |
| Ex. 1-2 | CAF-2 | 92 | 8 | 0 | 0 | 8 |
| Ex. 1-3 | CAF-3 | 92 | 8 | 0 | 0 | 8 |
| Ex. 1-4 | CAF-4 | 87 | 13 | 0 | 0 | 13 |
| Ex. 1-5 | CAF-5 | 72 | 28 | 0 | 0 | 28 |
| Ex. 1-6 | CAF-6 | 80 | 15 | 0 | 5 | 35 |
| Ex. 1-7 | CAF-7 | 69 | 31 | 0 | 0 | 31 |
| Ex. 1-8 | CAF-8 | 87 | 13 | 0 | 0 | 13 |
| Ex. 1-9 | CAF-9 | 80 | 20 | 0 | 0 | 20 |
| Ex. 1-10 | CAF-10 | 92 | 8 | 0 | 0 | 8 |
| Ex. 1-11 | CAF-11 | 92 | 8 | 0 | 0 | 8 |
| Ex. 1-12 | CAF-12 | 92 | 8 | 0 | 0 | 8 |
| Com. Ex. 1-1 | CAF-21 | 92 | 8 | 0 | 0 | 8 |
| Com. Ex. 1-2 | CAF-22 | 72 | 28 | 0 | 0 | 28 |
| Com. Ex. 1-3 | CAF-23 | 72 | 28 | 0 | 0 | 28 |
| Com. Ex. 1-4 | CAF-24 | 92 | 8 | 0 | 0 | 8 |
| Com. Ex. 1-5 | CAF-25 | 92 | 8 | 0 | 0 | 8 |

| | Cellulose acylate film (composition) | | | | | | |
|---|---|---|---|---|---|---|---|
| | | Additive 1 | | Additive 2 | | Additive 2 | |
| | | | Addition | | Addition | | Addition |
| | | | amount*¹ | | amount*¹ | | amount*¹ |
| | No. | Kind | (% by mass) | Kind | (% by mass) | Kind | (% by mass) |
| Ex. 1-1 | CAF-1 | TPP | 7.0 | BDP | 3.5 | A | 6.0 |
| Ex. 1-2 | CAF-2 | TPP | 7.0 | BDP | 3.5 | A | 9.0 |
| Ex. 1-3 | CAF-3 | TPP | 7.0 | BDP | 3.5 | A | 3.0 |
| Ex. 1-4 | CAF-4 | TPP | 7.0 | BDP | 3.5 | A | 6.0 |
| Ex. 1-5 | CAF-5 | TPP | 7.0 | BDP | 3.5 | A | 6.0 |
| Ex. 1-6 | CAF-6 | TPP | 7.0 | BDP | 3.5 | A | 6.0 |
| Ex. 1-7 | CAF-7 | TPP | 7.0 | BDP | 3.5 | A | 6.0 |
| Ex. 1-8 | CAF-8 | TPP | 7.0 | BDP | 3.5 | A | 6.0 |
| Ex. 1-9 | CAF-9 | Plasticizer A | 5.0 | Plasticizer B | 2.9 | Plasticizer C | 1.5 |
| Ex. 1-10 | CAF-10 | TPP | 7.0 | BDP | 3.5 | A | 6.0 |
| Ex. 1-11 | CAF-11 | TPP | 7.0 | BDP | 3.5 | A | 6.0 |
| Ex. 1-12 | CAF-12 | TPP | 7.0 | BDP | 3.5 | A | 6.0 |
| Com. Ex. 1-1 | CAF-21 | TPP | 7.0 | BDP | 3.5 | A | 6.0 |
| Com. Ex. 1-2 | CAF-22 | TPP | 7.0 | BDP | 3,5 | A | 6.0 |
| Com. Ex. 1-3 | CAF-23 | TPP | 7.0 | BDP | 3.5 | A | 6.0 |
| Com. Ex. 1-4 | CAF-24 | TPP | 7.0 | BDP | 3.5 | A | 3.0 |
| Com. Ex. 1-5 | CAF-25 | TPP | 7.0 | BDP | 3.5 | A | 6.0 |

Addition amount*¹: % by mass on the basis of the mass of film
Plasticizer A:

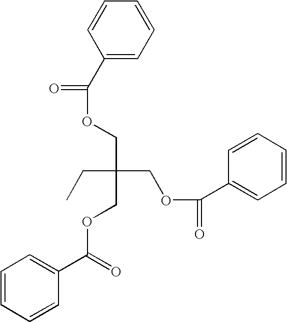

Plasticizer B:

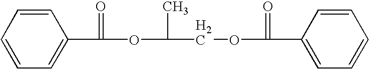

Plasticizer C

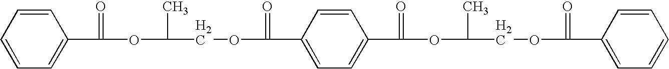

TABLE 2

| | | Content of | | | | |
|---|---|---|---|---|---|---|
| | | residual | | | | |
| | | solvent at | | | | |
| | Gel point of | the start of | Stretching | Stretching | Stretching | Film |
| | dope | stretching | temperature | ratio | rate | thickness |
| | ((C.) | (% by mass) | ((C.) | (%) | (%/min) | ((m) |
| Ex. 1-1 | Not observed | 60 | 130 | 25 | 35 | 80 |
| Ex. 1-2 | Not observed | 65 | 130 | 30 | 35 | 51 |
| Ex. 1-3 | Not observed | 62 | 130 | 30 | 35 | 52 |
| Ex. 1-4 | Not observed | 71 | 125 | 20 | 35 | 81 |
| Ex. 1-5 | Not observed | 54 | 135 | 25 | 35 | 80 |
| Ex. 1-6 | Not observed | 87 | 110 | 25 | 35 | 82 |
| Ex. 1-7 | Not observed | 51 | 130 | 25 | 35 | 79 |
| Ex. 1-8 | Not observed | 72 | 115 | 25 | 35 | 81 |
| Ex. 1-9 | Not observed | 78 | 120 | 35 | 35 | 80 |
| Ex. 1-10 | Not observed | 60 | 130 | 25 | 95 | 80 |
| Ex. 1-11 | Not observed | 60 | 130 | 25 | 15 | 80 |
| Ex. 1-12 | Not observed | 60 | 130 | 25 | 5 | 80 |
| Com. Ex. 1-1 | Not observed | 15 | 150 | 25 | 35 | 81 |
| Com. Ex. 1-2 | −7 (C. | 19 | 150 | 25 | 35 | 80 |
| Com. Ex. 1-3 | −7 (C. | 11 | 150 | 25 | 35 | 51 |
| Com. Ex. 1-4 | Not observed | 12 | 150 | 30 | 35 | 53 |
| Com. Ex. 1-5 | Not observed | 60 | 130 | 25 | 150 | 80 |

### [Measurement of Gel Point]

When storage elastic modulus and loss elastic modulus were measured by using a rheometer (Physica MCR301, manufactured by Anton Paar GmbH) while decreasing the measurement temperature from a high-temperature side to a low-temperature side of 30 (C to −15 (C, a temperature at which the both values are equal to each other was defined as the gel point. The gel point was measured ten times at intervals of 10 seconds under a condition at a strain of 1% and a frequency of 1 Hz, and an average value thereof was determined and described in Table 2. A sample in which the gel point was not observed even by decreasing the temperature to −15 (C is designated as “not observed”.

### [Measurement of Tg]

The measurement of the glass transition temperature (Tg) was carried out by using a dynamic viscoelasticity meter (Vibron DVA-225, manufactured by IT Keisoku Seigyo Co., Ltd.). A cellulose acylate sample of the invention having a size of 5 mm×30 mm was humidified at 25° C. and at a relative humidity of 60% for 2 hours or more and then measured at a grasping distance of 20 mm and a temperature rise rate of 2° C./min in the measurement temperature range of from 30° C. to 200° C. at a frequency of 1 Hz. The resulting data were then plotted with a storage elastic modulus as the logarithmic ordinate and a temperature (° C.) as the linear abscissa. A straight line 1 indicating a sudden reduction of storage elastic modulus developed when the sample shows transition from a solid region to a glass transition region is drawn in the solid material region. A straight line 2 is drawn in the glass transition region. A point of crossing of the straight line 1 and the straight line 2 is defined as a glass transition temperature Tg.

### [Measurement of Film Characteristic Values]

[Measurement of Retardation]

A sample was cut out into a size of 1 m (width direction)×1 m (longitudinal direction) and measured with respect to Re and Rth at a wavelength of 590 μm in 25 points in total of every 20 cm in the width direction and every 20 cm in the longitudinal direction under temperature and relative humidity at 25° C. and 60% RH by using an automatic birefringence meter, KOBRA 21ADH (manufactured by Oji Scientific Instruments).

Furthermore, a coefficient of fluctuation in Re from their average value, maximum value and minimum value in the foregoing 25 points on the basis of the following numerical expression (2).

(Coefficient of fluctuation in Re)=100×[(Maximum value of Re)−(Minimum value of Re)]/(Average value of Re) Numerical Expression (2)

### [Measurement of Out-of-Plane Orientation]

Each of a cross section parallel to the xz plane of the film and a cross section parallel to the yz plane of the film was divided equally into 5 parts from the support side to the side of the interface with air at the fabrication, and a degree of orientation in the film cross section of each of these parts was measured by using X-ray beams of from several μm to several tens μm.

X-rays were emitted at 50 KV and 300 mA from D8 DISCOVER (manufactured by Bruker AXS K.K.) by using a rotating anode using a Cu target as an X-ray source. A collimator was set up at 0.02 mmφ, and a film sample was fixed by using a transmitted sample table. Also, the exposure time was set up at one hour.

The degree of out-of-plane orientation was calculated on the basis of the following numerical expression (9).

(Degree of out-of-plane orientation)=[(Degree of orientation of cellulose acylate molecular chain on the xz plane)+(Degree of orientation of cellulose acylate molecular chain on the yz plane)]/2 Numerical Expression (9)

The obtained results are shown in Table 3.

TABLE 3

| | Retardation value | | | |
|---|---|---|---|---|
| | | Coefficient of | | |
| | Average value | fluctuation in | Average value | (Average value of Rth)/ |
| | of Re (nm) | Re (%) | of Rth (nm) | (Average value of Re) |
| Ex. 1-1 | 55 | 5 | 190 | 3.5 |
| Ex. 1-2 | 52 | 4 | 180 | 3.5 |
| Ex. 1-3 | 45 | 5 | 125 | 2.8 |
| Ex. 1-4 | 54 | 5 | 180 | 3.3 |
| Ex. 1-5 | 54 | 6 | 205 | 3.8 |
| Ex. 1-6 | 53 | 5 | 187 | 3.5 |
| Ex. 1-7 | 64 | 4 | 216 | 3.4 |
| Ex. 1-8 | 39 | 5 | 174 | 4.5 |
| Ex. 1-9 | 45 | 5 | 125 | 2.8 |
| Ex. 1-10 | 56 | 4 | 205 | 3.7 |
| Ex. 1-11 | 53 | 11 | 186 | 3.5 |
| Ex. 1-12 | 51 | 21 | 180 | 3.5 |
| Com. Ex. 1-1 | 54 | 4 | 187 | 3.5 |
| Com. Ex. 1-2 | 51 | 5 | 201 | 3.9 |
| Com. Ex. 1-3 | 30 | 5 | 125 | 4.2 |
| Com. Ex. 1-4 | 44 | 4 | 139 | 3.2 |
| Com. Ex. 1-5 | 57 | 4 | 225 | 3.9 |

| | Degree of out-of-plane orientation | | | | | |
|---|---|---|---|---|---|---|
| | From surface of | | From surface of | | | |
| | support side at | | air side at | | | |
| | the fabrication | | the fabrication | | | |
| | to a depth of | Central | to a depth of | Average | | Coefficient of |
| | 10 μm | part | 10 μm | value | Ps/Pc | fluctuation (%) |
| Ex. 1-1 | 0.126 | 0.088 | 0.105 | 0.101 | 1.43 | 37.6 |
| Ex. 1-2 | 0.120 | 0.092 | 0.108 | 0.107 | 1.30 | 26.2 |
| Ex. 1-3 | 0.119 | 0.093 | 0.108 | 0.106 | 1.28 | 24.5 |
| Ex. 1-4 | 0.120 | 0.092 | 0.108 | 0.108 | 1.30 | 25.9 |
| Ex. 1-5 | 0.097 | 0.119 | 0.094 | 0.103 | 0.82 | 21.4 |
| Ex. 1-6 | 0.092 | 0.115 | 0.087 | 0.098 | 0.80 | 23.5 |
| Ex. 1-7 | 0.095 | 0.110 | 0.093 | 0.099 | 0.86 | 15.2 |
| Ex. 1-8 | 0.093 | 0.112 | 0.090 | 0.098 | 0.83 | 19.4 |
| Ex. 1-9 | 0.120 | 0.087 | 0.104 | 0.104 | 1.38 | 31.7 |
| Ex. 1-10 | 0.115 | 0.099 | 0.105 | 0,106 | 1.16 | 15.1 |
| Ex. 1-11 | 0.118 | 0.076 | 0.102 | 0.099 | 1.55 | 42.4 |
| Ex. 1-12 | 0.116 | 0.074 | 0.100 | 0.097 | 1.57 | 43.3 |
| Com. Ex. 1-1 | 0.089 | 0.085 | 0.087 | 0.087 | 1.05 | 4.6 |
| Com. Ex. 1-2 | 0.093 | 0.097 | 0.095 | 0.095 | 0.98 | 2.1 |
| Com. Ex. 1-3 | 0.095 | 0.097 | 0.096 | 0.096 | 0.99 | 1.0 |
| Com. Ex. 1-4 | 0.088 | 0.084 | 0.086 | 0.096 | 1.05 | 4.2 |
| Com. Ex. 1-5 | 0.117 | 0.109 | 0.112 | 0.111 | 1.07 | 7.2 |

### [Preparation of Polarizing Plate]

### Examples 2-1 to 2-12 and Comparative Examples 2-1 to 2-6

### Saponification Treatment of Cellulose Acetate Film

Each of the cellulose acetate films as prepared in the foregoing Examples 1-1 to 1-12 and Comparative Examples 1-1 to 1-5 was dipped in 1.4 moles/L of a sodium hydroxide aqueous solution at 55° C. for 2 minutes, washed in a water washing bath at room temperature and then neutralized with 0.05 moles/L of sulfuric acid at 30° C. Next, the resulting film was again washed in a water washing bath at room temperature and further dried by warm air at 110° C. The surface of each of the cellulose acetate films was thus saponified.

Also, each of commercially available cellulose acetate films, FUJITAC TD80UF and FUJITAC T40UZ (all of which are manufactured by Fujifilm Corporation) was saponified under the same condition and provided for the following preparation of a polarizing plate sample.

### [Preparation of Polarizer]

A polarizer was prepared by adsorbing iodine on a stretched PVA film, and the cellulose acetate film (CAF-1) as prepared in Example 1-1 was stuck on one side of the polarizer by using a PVA based adhesive. A transmission axis of the polarizer and a slow axis of the cellulose acetate film were disposed such that the both were parallel to each other.

Furthermore, the foregoing saponified “FUJITAC TD80UF” was stuck on the opposite side of the polarizer by using a PVA based adhesive. There was thus prepared a polarizing plate (P1-1).

With respect to other cellulose acetate films of the invention, polarizing plates (P1-2) to (P1-12) and (PR1-1) to (PR1-7) were prepared in the same manner as described above by combining with FUJITAC TD80UF or T40UZ.

### [Evaluation of Curl of Polarizing Plate]

Each of the polarizing plates as prepared in Examples 2-1 to 2-12 and Comparative Examples 2-1 to 2-6 was cut out into a size of 25 cm×25 cm, allowed to stand on a horizontal table under a circumference at 25° C. and 60% RH and humidified for 2 hours. Then, curl was evaluated according to the following criteria.

A: A gap between the horizontal table and the both ends of the polarizing plate is less than 0.5 cm.

B: A gap between the horizontal table and the both ends of the polarizing plate is 0.5 cm or more and not more than 1 cm.

C: A gap between the horizontal table and the both ends of the polarizing plate exceeds 1 cm.

The obtained results are shown in Table 4. It was noted from the results as shown in Table 4 that the polarizing plates (P1-1) to (P1-12) of the invention were small in curl and favorable as compared with the comparative polarizing plate (PR1-5).

TABLE 4

| | Polarizing | Polarizing | | |
|---|---|---|---|---|
| | plate | plate | | |
| | protective | protective | | |
| | film 1 | film 2 | Curl | Remark |
| Polarizing plate | CAF-1 | FUJITAC TD80UF | A | Invention |
| 1-1 | | | | |
| Polarizing plate | CAF-2 | FUJITAC T40UZ | A | Invention |
| 1-2 | | | | |
| Polarizing plate | CAF-3 | FUJITAC T40UZ | A | Invention |
| 1-3 | | | | |
| Polarizing plate | CAF-4 | FUJITAC TD80UF | A | Invention |
| 1-4 | | | | |
| Polarizing plate | CAF-5 | FUJITAC TD80UF | A | Invention |
| 1-5 | | | | |
| Polarizing plate | CAF-6 | FUJITAC TD80UF | A | Invention |
| 1-6 | | | | |
| Polarizing plate | CAF-7 | FUJITAC TD80UF | A | Invention |
| 1-7 | | | | |
| Polarizing plate | CAF-8 | FUJITAC TD80UF | A | Invention |
| 1-8 | | | | |
| Polarizing plate | CAF-9 | FUJITAC TD80UF | A | Invention |
| 1-9 | | | | |
| Polarizing plate | CAF-10 | FUJITAC TD80UF | A | Invention |
| 1-10 | | | | |
| Polarizing plate | CAF-11 | FUJITAC TD80UF | A | Invention |
| 1-11 | | | | |
| Polarizing plate | CAF-12 | FUJITAC TD80UF | A | Invention |
| 1-12 | | | | |
| Polarizing plate | CAF-21 | FUJITAC TD80UF | A | Comparison |
| PR-1 | | | | |
| Polarizing plate | CAF-22 | FUJITAC TD80UF | A | Comparison |
| PR-2 | | | | |
| Polarizing plate | CAF-23 | FUJITAC T40UZ | A | Comparison |
| PR-3 | | | | |
| Polarizing plate | CAF-24 | FUJITAC T40UZ | A | Comparison |
| PR-4 | | | | |
| Polarizing plate | CAF-23 | FUJITAC TD80UF | C | Comparison |
| PR-5 | | | | |
| Polarizing plate | CAF-24 | FUJITAC TD80UF | C | Comparison |
| PR-6 | | | | |
| Polarizing plate | CAF-25 | FUJITAC TD80UF | A | Comparison |
| PR-7 | | | | |

### Example 3-1

### Preparation and Evaluation 1 of VA Mode Liquid Crystal Display

A liquid crystal display as illustrated in FIG. 3 was prepared.

That is, an upper polarizing plate, a VA mode liquid crystal cell (including an upper substrate, a liquid crystal layer and a lower substrate) and a lower polarizing plate were stacked from the observation direction (upper part), and a backlight light source was further disposed.

In the following examples, a commercially available product, HLC2-5618 (manufactured by Sanritz Corporation) is used as the upper polarizing plate, and the polarizing plate of the invention is used as the lower polarizing plate.

### [Preparation of Liquid Crystal Cell]

A liquid crystal cell was prepared by setting up a cell gap between substrates at 3.6 μm and dropping, injecting and sealing a liquid crystal material having negative dielectric anisotropy (MLC6608, manufactured by Merck) between the substrates, thereby forming a liquid crystal layer between the substrates. A retardation of the liquid crystal layer [namely, a product Δn·d of a thickness d (μm) of the liquid crystal layer and a refractive index anisotropy Δn] was set up at 300 nm. The liquid crystal material was vertically oriented.

In the liquid crystal display (as illustrated in FIG. 3) in which the vertically oriented liquid crystal cell as obtained above was used, the foregoing commercially available product, HLC2-5618 which is a super-high contrast product as the upper polarizing plate and the polarizing plate (P1-1) as prepared in Example 2-1 as the lower polarizing plate were stuck to the liquid crystal cell, respectively via an adhesive such that the cellulose acetate film (CAF-1) as one of the protective films was faced at the liquid crystal cell side. The stack was disposed in a state of cross Nicols such that the transmission axis of the polarizing plate on the observer side is in the vertical direction, whereas the transmission axis of the polarizing plate on the backlight side is in the horizontal direction.

### Examples 3-2 to 3-10 and Comparative Examples 3-1 to 3-5

Next, liquid crystal displays 1-1 to 1-15 were prepared in the same manner as described above by using each of the polarizing plates as prepared in Examples 2-2, 2-4 to 2-8 and 2-10 to 2-12 and Comparative Examples 2-1 to 2-3, 2-5 and 2-6 for the lower polarizing plate.

### [Evaluation of Display Unevenness]

Each of the liquid crystal displays as prepared in Examples 3-1 to 3-10 and Comparative Examples 3-1 to 3-5 was continuously lighted for 500 hours under a temperature and relative humidity condition at 35° C. and 80% RH, and an area where unevenness was generated was evaluated according to the following criteria.

A: Unevenness is not viewed.

B: An area where unevenness is viewed is less than 10% of the whole.

C: An area where unevenness is view is 10% or more of the whole.

The obtained results are shown in Table 5. It was noted from the results as shown in Table 5 that even when continuously lighted under a high-temperature and high-humidity condition, the liquid crystal displays of the invention hardly generate unevenness and are favorable.

TABLE 5

| | Polarizing plate | Polarizing plate | | |
|---|---|---|---|---|
| | on backlight side | on observer side | Unevenness | Remark |
| Liquid crystal display 1-1 | Polarizing plate P1-1 | HLC2-5618 | A | Invention |
| Liquid crystal display 1-2 | Polarizing plate P1-2 | HLC2-5618 | A | Invention |
| Liquid crystal display 1-3 | Polarizing plate P1-4 | HLC2-5618 | A | Invention |
| Liquid crystal display 1-4 | Polarizing plate P1-5 | HLC2-5618 | A | Invention |
| Liquid crystal display 1-5 | Polarizing plate P1-6 | HLC2-5618 | A | Invention |
| Liquid crystal display 1-6 | Polarizing plate P1-7 | HLC2-5618 | A | Invention |
| Liquid crystal display 1-7 | Polarizing plate P1-8 | HLC2-5618 | A | Invention |
| Liquid crystal display 1-8 | Polarizing plate P1-10 | HLC2-5618 | A | Invention |
| Liquid crystal display 1-9 | Polarizing plate P1-11 | HLC2-5618 | A | Invention |
| Liquid crystal display 1-15 | Polarizing plate P1-12 | HLC2-5618 | A | Invention |
| Liquid crystal display 1-10 | Polarizing plate PR-1 | HLC2-5618 | C | Comparison |
| Liquid crystal display 1-11 | Polarizing plate PR-2 | HLC2-5618 | C | Comparison |
| Liquid crystal display 1-12 | Polarizing plate PR-3 | HLC2-5618 | C | Comparison |
| Liquid crystal display 1-13 | Polarizing plate PR-5 | HLC2-5618 | B | Comparison |
| Liquid crystal display 1-14 | Polarizing plate PR-6 | HLC2-5618 | B | Comparison |
| Liquid crystal display 1-16 | Polarizing plate PR-7 | HLC2-5618 | C | Comparison |

### [Preparation and Evaluation 2 of VA Mode Liquid Crystal Display]

1 part by mass of octadecyl dimethyl ammonium chloride (coupling agent) was added in 100 parts by mass of a 3% by mass PVA aqueous solution. The mixture was spin coated on a glass substrate equipped with an ITO electrode and heated at 160° C., followed by subjecting a rubbing treatment to form a vertically oriented membrane. The rubbing treatment was carried out in such a manner that two glass substrates were faced opposite to each other. The two glass substrates were faced at each other such that a cell gap (d) was 5 μm. A liquid crystalline compound (Δn: 0.08) containing as main components an ester based compound and an ethane based compound was injected in the cell gap, thereby preparing a vertically oriented liquid crystal cell. A product of Δn and d (namely a retardation of the liquid crystal layer) was 400 nm.

The polarizing plate as prepared in Example 2-3 (P1-3, a polarizing plate in which the cellulose acetate film (CAF-3) of the invention is used) was previously humidified under a temperature and relative humidity condition at 25° C. and 60% RH, packaged in a bag having been subjected to a moisture-proof treatment and then allowed to stand for 3 days. The bag was a packaging material having a stack structure of polyethylene terephthalate/aluminum/polyethylene, and a water vapor permeability was not more than 1×10⁻⁵ g/m² day. The polarizing plate (P1-3) was taken out under a circumstance at 25° C. and 60% RH and stuck on the both surfaces of the vertically oriented liquid crystal cell as prepared above by using an adhesive sheet such that the cellulose acetate film (CAF-3) of the invention was faced on the liquid crystal cell side, thereby preparing a liquid crystal display.

It was noted that even when continuously lighted for 500 hours or more under a temperature and relative humidity condition at 35° C. and 80% RH, the liquid crystal display using the polarizing plate of the invention hardly generates unevenness and is favorable.

### [Preparation of Cellulose Acylate Film]

### Example 4-1

### Preparation of Cellulose Acetate Film (CAF-41)

### [Preparation of Cellulose Acetate Stock Solution (CAL-41)]

The following composition was thrown into a mixing tank and stirred to dissolve the respective components, thereby preparing a cellulose acetate stock solution (CAL-41).

[Composition of cellulose acetate stock solution (CAL-41)]

| | |
|---|---|
| Cellulose acetate (acetylation degree: 2.85): | 100.0 parts by mass |
| Triphenyl phosphate (TPP): | 7.0 parts by mass |
| Biphenyl phosphate (BDP): | 3.5 parts by mass |
| Methylene chloride (first solvent): | 401.9 parts by mass |
| Methanol (second solvent): | 60.1 parts by mass |

### [Preparation of Matting Agent Solution (Ma-41)]

The following composition was thrown into a dispersing machine and stirred to dissolve the respective components, thereby preparing a matting agent solution (Ma-41).

[Composition of matting agent solution (Ma-41)]

| | |
|---|---|
| Silica particle having an average particle | 2.0 parts by mass |
| size of 20 nm (AEROSIL R972, manufactured | |
| by Nippon Aerosil Co., Ltd.): | |
| Methylene chloride (first solvent): | 76.2 parts by mass |
| Methanol (second solvent): | 11.4 parts by mass |
| Cellulose acetate stock solution (CAL-41): | 10.3 parts by mass |

### [Preparation of Additive Solution (Ad-41)]

The following composition was thrown into a mixing tank and stirred while heating to dissolve the respective components, thereby preparing an additive solution (Ad-41).

[Composition of additive solution (Ad-41)]

| | |
|---|---|
| Triphenyl phosphate (TPP): | 20.0 parts by mass |
| Methylene chloride (first solvent): | 58.4 parts by mass |
| Methanol (second solvent): | 8.7 parts by mass |
| Cellulose acetate stock solution (CAL-41): | 12.8 parts by mass |

### [Preparation of Cellulose Acetate Film (CAF-41)]

93.7 pars by mass of the cellulose acetate stock solution (CAL-41), 1.3 parts by mass of the matting agent solution (Ma-41) and 5.0 parts by mass of the additive solution (Ad-41) were respectively filtered and then mixed, and the mixture was cast by using a band casting machine. Drying was carried out on the support at a support temperature of 20° C. while blowing dry air at 120° C. A proportion of the poor solvent (methanol) at the content of the residual solvent of 160% relative to the total solvents was 15%. A film obtained at the content of the residual solvent of 55% by mass was separated from the band and laterally stretched by 30% at a stretching rate of 30%/min at a circumferential temperature of 140° C. by using a tenter, thereby producing a cellulose acetate film (CAF-41). The content of the residual solvent at the start of stretching was 60% by mass. Details of the composition of each of the cellulose acetate film and dope solvent and the stretching condition are shown in Tables 6 and 7.

### (Composition of Poor Solvent Relative to Total Solvents in Residual Solvent)

A composition of the poor solvent relative to the total solvents was measured by using a GC-14A gas chromatograph, manufactured by Shimadzu Corporation. Gaskuropack 54, manufactured by Shinwa Chemical Industries, Ltd. was used as a column.

### Examples 4-2 to 4-6

### Preparation of Cellulose Acetate Films (CAF-42) to (CAF-46)

Cellulose acetate films (CAF-42) to (CAF-46) were prepared in the same manner as in Example 4-1, except that in the preparation of the cellulose film (CAF-41), the composition of the dope solvent, the kind of cellulose acetate, the kind and addition amount of the additive, the stretching condition and the ratio of the poor solvent were changed as shown in Tables 6 and 7.

### Comparative Example 4-1

### Preparation of Cellulose Acetate Film (CAF-51)

A cellulose acetate film (CAF-51) was prepared in the same manner as in Example 4-1, except that in the preparation of the cellulose film (CAF-41), the composition of the dope solvent, the kind of cellulose acetate, the kind and addition amount of the additive, the stretching condition and the ratio of the poor solvent were changed as shown in Tables 6 and 7.

TABLE 6

Cellulose acylate film (composition)

| | | Cellulose acylate | | |
|---|---|---|---|---|
| | | Total acyl | | |
| | No. | substitution degree | Acetylation degree | Propioylation degree |
| Ex. 4-1 | CAF-41 | 2.85 | 2.85 | — |
| Ex. 4-2 | CAF-42 | 2.85 | 2.85 | — |
| Ex. 4-3 | CAF-43 | 2.85 | 2.85 | — |
| Ex. 4-4 | CAF-44 | 2.85 | 2.85 | — |
| Ex. 4-5 | CAF-45 | 2.85 | 2.85 | — |
| Ex. 4-6 | CAF-46 | 2.85 | 2.85 | — |
| Com. Ex. 4-1 | CAF-51 | 2.85 | 2.85 | — |

| | Cellulose acylate film (composition) | | | |
|---|---|---|---|---|
| | | Composition of dope solvent | | |
| | | Methylene chloride | Methanol | Ethanol |
| | No. | (good solvent) (% by mass) | (poor solvent) (% by mass) | (poor solvent) (% by mass) |
| Ex. 4-1 | CAF-41 | 87 | 13 | 0 |
| Ex. 4-2 | CAF-42 | 87 | 13 | 0 |
| Ex. 4-3 | CAF-43 | 87 | 13 | 0 |
| Ex. 4-4 | CAF-44 | 87 | 13 | 0 |
| Ex, 4-5 | CAF-45 | 87 | 13 | 0 |
| Ex. 4-6 | CAF-46 | 87 | 13 | 0 |
| Com. Ex. 4-1 | CAF-51 | 87 | 13 | 0 |

| | Cellulose acylate film (composition) | | | | | | |
|---|---|---|---|---|---|---|---|
| | | Additive 1 | | Additive 2 | | Additive 2 | |
| | | | Addition | | Addition | | Addition |
| | | | amount*¹ | | amount*¹ | | amount*¹ |
| | No. | Kind | (% by mass) | Kind | (% by mass) | Kind | (% by mass) |
| Ex. 4-1 | CAF-41 | TPP | 13.0 | BDP | 3.5 | — | 0.0 |
| Ex. 4-2 | CAF-42 | TPP | 7.0 | BDP | 3.5 | — | 0.0 |
| Ex. 4-3 | CAF-43 | TPP | 6.0 | BDP | 4.0 | Orientation | 3.0 |
| | | | | | | adjusting agent | |
| | | | | | | 4 (log P = 7.8) | |
| Ex. 4-4 | CAF-44 | TPP | 4.0 | BDP | 2.0 | Orientation | 7.0 |
| | | | | | | adjusting agent | |
| | | | | | | 4 (log P = 7.8) | |
| Ex. 4-5 | CAF-45 | TPP | 5.0 | BDP | 3.0 | Orientation | 5.0 |
| | | | | | | adjusting agent | |
| | | | | | | 1 (log P = 7.8) | |
| Ex. 4-6 | CAF-46 | TPP | 5.0 | BDP | 3.0 | Orientation | 5.0 |
| | | | | | | adjusting agent | |
| | | | | | | 6 (log P = 7.8) | |
| Com. Ex. 4-1 | CAF-51 | TPP | 7.0 | BDP | 3.5 | — | 0.0 |

Addition amount*¹: % by mass on the basis of the mass of film

TABLE 7

| | | | | | (Ratio of poor solvent |
|---|---|---|---|---|---|
| | | | | | to total solvents at the |
| | | | | Ratio of poor solvent | content of residual |
| | | Drying of support | | to good solvent at the | solvents of 160%)/ |
| | Gel point | Temperature | Temperature | content of residual | (Ratio of poor solvent to |
| | of dope | of dry air | of support | solvents of 160% | total solvents in dope) |
| | ((C.) | ((C.) | ((C.) | (%) | (%) |
| Ex. 4-1 | Not | 120 | 20 | 15 | 1.15 |
| | observed | | | | |
| Ex. 4-2 | Not | 30 | 35 | 20 | 1.54 |
| | observed | | | | |
| Ex. 4-3 | Not | 30 | 35 | 19 | 1.46 |
| | observed | | | | |
| Ex. 4-4 | Not | 30 | 35 | 23 | 1.77 |
| | observed | | | | |
| Ex. 4-5 | Not | 30 | 35 | 21 | 1.62 |
| | observed | | | | |
| Ex. 4-6 | Not | 30 | 35 | 17 | 1.31 |
| | observed | | | | |
| Com. Ex. 4-1 | Not | 80 | 20 | 15 | 1.15 |
| | observed | | | | |

| | Content of residual | | | | |
|---|---|---|---|---|---|
| | solvent at the | Stretching | Stretching | Stretching | Film |
| | start of stretching | temperature | ratio | rate | thickness |
| | (% by mass) | (° C.) | (%) | (%/min) | (μm) |
| Ex. 4-1 | 30 | 140 | 30 | 50 | 55 |
| Ex. 4-2 | 34 | 140 | 30 | 50 | 55 |
| Ex. 4-3 | 32 | 140 | 30 | 50 | 55 |
| Ex. 4-4 | 33 | 140 | 30 | 50 | 75 |
| Ex. 4-5 | 34 | 140 | 30 | 50 | 65 |
| Ex. 4-6 | 33 | 140 | 30 | 50 | 45 |
| Com. Ex. 4-1 | 12 | 150 | 30 | 50 | 55 |

Film characteristics of these films as determined in the same manner as in Examples 1-1 to 1-12 are shown in Table 8.

TABLE 8

| | Retardation value | | | |
|---|---|---|---|---|
| | | Coefficient of | | |
| | Average value | fluctuation in | Average value | (Average value of Rth)/ |
| | of Re (nm) | Re (%) | of Rth (nm) | (Average value of Re) |
| Ex. 4-1 | 10 | 3 | 42 | 4.2 |
| Ex. 4-2 | 11 | 3 | 41 | 3.7 |
| Ex. 4-3 | 45 | 4 | 135 | 3.0 |
| Ex. 4-4 | 25 | 4 | 112 | 4.5 |
| Ex. 4-5 | 51 | 4 | 114 | 2.2 |
| Ex. 4-6 | 36 | 4 | 102 | 2.8 |
| Com. Ex. 4-1 | 54 | 4 | 187 | 3.5 |

| | Degree of out-of-plane orientation | | | | | |
|---|---|---|---|---|---|---|
| | From surface of | | From surface of | | | |
| | support side at | | air side at | | | |
| | the fabrication | | the fabrication | | | |
| | to a depth of | Central | to a depth of | Average | | Coefficient of |
| | 10 μm | part | 10 μm | value | Ps/Pc | fluctuation (%) |
| Ex. 4-1 | 0.122 | 0.092 | 0.106 | 0.106 | 1.33 | 28.3 |
| Ex. 4-2 | 0.129 | 0.087 | 0.108 | 0.109 | 1.48 | 38.5 |
| Ex. 4-3 | 0.132 | 0.085 | 0.109 | 0.109 | 1.55 | 43.1 |
| Ex. 4-4 | 0.136 | 0.082 | 0.110 | 0.109 | 1.66 | 49.5 |
| Ex. 4-5 | 0.133 | 0.084 | 0.110 | 0.109 | 1.58 | 45.0 |
| Ex. 4-6 | 0.126 | 0.089 | 0.108 | 0.108 | 1.42 | 34.3 |
| Com. Ex. 4-1 | 0.090 | 0.084 | 0.087 | 0.087 | 1.07 | 6.9 |

Each of the thus prepared cellulose acetate films of the invention (CAF-41 to CAF-46) and comparative cellulose acetate film (CAF-51) was subjected to a saponification treatment and processing into a polarizing plate in the same manner as in the cellulose acetate film (CAF-1) and then evaluated in the same manner as in Example 3.

When continuously lighted for 500 hours under a temperature and relative humidity condition at 35° C. and 80% RH, a liquid crystal device using each of the cellulose acetate films of the invention (CAF-41 to CAF-46) was small in an area where unevenness is generated as compared with a liquid crystal display using the comparative cellulose acetate film (CAF-51) and was favorable.

In particular, a liquid crystal display using a film as prepared by using an orientation adjusting agent having a ratio of a poor solvent at the content of the residual solvent of 1.1 times or more of a ratio of a poor solvent in a dope was substantially free from unevenness and was especially favorable.

This application is based on Japanese Patent application JP 2006-281559, filed Oct. 16, 2006, the entire content of which is hereby incorporated by reference, the same as if fully set forth herein.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. A polymer film having a coefficient of fluctuation in degree of out-of-plane orientation of a polymer molecular chain in a thickness direction of the film as represented by the following numerical expression (1) of from 15% to 80%:
(Coefficient of fluctuation in degree of out-of-plane orientation)=100×[(Maximum value of degree of out-of-plane orientation)−(Minimum value of degree of out-of-plane orientation)]/(Average value of degree of out-of-plane orientation in thickness direction) Numerical Expression (1)

2. The polymer film according to claim 1, having a coefficient of fluctuation in in-plane retardation Re at a wavelength of 590 nm as represented by the following numerical expression (2) of not more than 20%:
(Coefficient of fluctuation in Re)=100×[(Maximum value of Re)−(Minimum value of Re)]/(Average value of Re) Numerical Expression (2)

3. The polymer film according to claim 1, wherein when a larger value between an average value of degrees of out-of-plane orientation of a polymer molecular chain in a region of from a surface of one side of the film to a depth of 10 μm and an average value of degrees of out-of-plane orientation of a polymer molecular chain in a region of from a surface of opposite side of the film to a depth of 10 μm is defined as Ps and a degree of out-of-plane orientation of a polymer molecular chain in a center in a thickness direction of the film is defined as Pc, Ps and Pc are satisfied with a relationship of the following numerical expression (3):
1.15≦Ps/Pc≦2.00 Numerical Expression (3)

4. The polymer film according to claim 1, wherein when a larger value between an average value of degrees of out-of-plane orientation of a polymer molecular chain in a region of from a surface of one side of the film to a depth of 10 μm and an average value of degrees of out-of-plane orientation of a polymer molecular chain in a region of from a surface of opposite side of the film to a depth of 10 μm is defined as Ps and a degree of out-of-plane orientation of a polymer molecular chain in a center in a thickness direction of the film is defined as Pc, Ps and Pc are satisfied with a relationship of the following numerical expression (4):
0.50≦Ps/Pc≦0.95 Numerical Expression (4)

5. The polymer film according to claim 1, wherein an in-plane retardation Re at a wavelength of 590 nm and a retardation Rth in a thickness direction are satisfied with relationships of the following numerical expressions (5) to (7):
20≦Re≦200 Numerical Expression (5)
70≦Rth≦400 Numerical Expression (6)
1≦Rth/Re≦10 Numerical Expression (7)

6. The polymer film according to claim 1, wherein the film has a thickness of from 20 μm to 100 μm.

7. A process for producing a polymer film comprising:
casting a dope containing a polymer and a solvent and having a gel point of no higher than −15° C. on a support;
drying the cast dope to form a film;
stripping off the film from the support; and
stretching the stripped-off film,
wherein a content of a residual solvent at a start of the stretching as represented by the following numerical expression (8) is from 20% to 140%, and a stretching rate is from 5%/min to 100%/min:
[Content of residual solvent(% by mass)]=100×{[Film mass(g)]−[Film mass(g)after drying at 120° C. for 2 hours]}/[Film mass(g)after drying at 120° C. for 2 hours] Numerical Expression (8)

8. The process for producing a polymer film according to claim 7, wherein the dope contains a polymer and a poor solvent and a good solvent relative to the polymer, and at a point of time when the content of the residual solvent represented by the numerical expression (8) is 160%, a ratio of the poor solvent to the total solvents is 1.2 times or more of a ratio of the poor solvent to the total solvents in the dope.

9. A process for producing a polymer film comprising:
casting a dope containing a polymer and a solvent and having a gel point of −10° C. or higher on a support;
drying the cast dope to form a film;
stripping off the film from the support; and
stretching the stripped-off film,
wherein a content of a residual solvent at a start of the stretching as represented by the following numerical expression (8) is from 20% to 140%, and a stretching rate is from 5%/min to 100%/min:
[Content of residual solvent(% by mass)]=100×{[Film mass(g)]−[Film mass(g)after drying at 120° C. for 2 hours]}/[Film mass(g)after drying at 120° C. for 2 hours] Numerical Expression (8)

10. The polymer film according to claim 1, which is produced by a process, the process comprising: casting a dope containing a polymer and a solvent and having a gel point of no higher than −15° C. on a support; drying the cast dope to form a film; stripping off the film from the support; and stretching the stripped-off film, wherein a content of a residual solvent at a start of the stretching as represented by the following numerical expression (8) is from 20% to 140%, and a stretching rate is from 5%/min to 100%/min:
[Content of residual solvent(% by mass)]=100×{[Film mass(g)]−[Film mass(g)after drying at 120° C. for 2 hours]}/[Film mass(g)after drying at 120° C. for 2 hours] Numerical Expression (8)

11. The polymer film according to claim 1, which is produced by a process, the process comprising: casting a dope containing a polymer and a solvent and having a gel point of −10° C. or higher on a support; drying the cast dope to form a film; stripping off the film from the support; and stretching the stripped-off film, wherein a content of a residual solvent at a start of the stretching as represented by the following numerical expression (8) is from 20% to 140%, and a stretching rate is from 5%/min to 100%/min:
[Content of residual solvent(% by mass)]=100×{[Film mass(g)]−[Film mass(g)after drying at 120° C. for 2 hours]}/[Film mass(g)after drying at 120° C. for 2 hours] Numerical Expression (8)

12. The polymer film according to claim 1, wherein the polymer film comprises cellulose acylate.

13. A polarizing plate comprising a protective film stuck on both sides of a polarizer, wherein at least one of the protective films is the polymer film according to claim 1.

14. A liquid crystal display comprising a liquid crystal cell and two polarizing plates disposed on both sides of the liquid crystal cell, wherein at least one of the polarizing plates is the polarizing plate according to claim 13.
